(19) United States
(12) Patent Application Publication
(10) Pub. No.: US 2024/0148004 A1
(43) Pub. Date: May 9, 2024

(54) METHODS AND COMPOSITIONS FOR INCREASING TOLERANCE TO STRESS IN PLANTS

(71) Applicant: DANSTAR FERMENT AG, ZUG (CH)

(72) Inventors: Javier TÉLLEZ, Zug (CH); Fabrizio BATTISTA, Zug (CH); Ildar NISAMEDTINOV, Zug (CH); Carlos SUÁREZ MARTÍNEZ, Zug (CH)

(73) Assignee: DANSTAR FERMENT AG, ZUG (CH)

(21) Appl. No.: 18/548,689

(22) PCT Filed: Mar. 3, 2022
(86) PCT No.: PCT/EP2022/055386

§ 371 Date: Sep. 1, 2023

(30) Foreign Application Priority Data
Mar. 3, 2021 (EP) 21382178.8

(51) Int. Cl. A01N 63/32; A01N 43/36; A01P 21/00

(52) U.S. Cl. CPC A01N 63/32; A01N 43/36; A01P 21/00

(57) ABSTRACT

A method for reducing the effects of abiotic stress and/or for increasing the tolerance to abiotic stress in a plant and/or a plant part comprising contacting a plant and/or a plant part with a composition comprising a yeast-derived material thereby reducing the effects of abiotic stress and/or for increasing the tolerance to abiotic stress in a plant and/or a plant part compared to an untreated plant and/or plant part.

### TECHNOLOGICAL FIELD

The present disclosure relates to the field of plant response to stress and provides methods and compositions for increasing tolerance to stress in plants.

### BACKGROUND

Abiotic stresses (or environmental stresses) negatively impact the growth and development of plants and result in significant reductions in crop yield and quality. Abiotic stresses, for example, include excessive or insufficient light intensity, cold temperature resulting in freezing or chilling, warm or high temperature, drought, ozone, salinity, toxic metals, toxic chemical pollution, nutrient poor soils, hail and other weather hazards and the like.

Most plants have evolved strategies to protect themselves against these conditions. For example, plants acclimate to particular stress conditions using responses that are specific for that stress. As an example, during drought conditions, a plant closes its stomata to reduce water loss. However, plants are often subjected to a combination of stresses. For example, drought conditions often are combined with excessive heat conditions. In contrast to a plant's response to drought, a plant's response to heat is to open stomata so that the leaves are cooled by transpiration. This conflict in response reduces a plant's ability to naturally adjust to such stresses.

If the intensity and duration of the stress conditions are too severe, the effects on the development, growth and yield of most crops are profound. In addition, most crop plants are very sensitive to abiotic stress and therefore require optimal growing conditions for commercial crop yield. Continuous exposure to stress leads to major changes in plant metabolism, ultimately leading to cell death and thus yield losses.

For example, it is well known that water shortage, high air temperatures and radiative excess are limiting factors increasing by frequency and intensity in most of the wine regions worldwide and the industry is actively seeking for new sustainable tools able to ameliorate vine resilience to climatic extremes.

A number of methods for alleviating abiotic stress in plants have been developed and are available commercially. Selecting stress-resistant cultivars can be an effective strategy to minimize reduced plant growth under adverse growing conditions. Conventional breeding is, however, a slow process to generate new crop varieties with better tolerance to stress conditions and stability of the new cultivars may be a limitation over successive plant generations. Also, genetic engineering efforts to confer abiotic stress tolerance to transgenic crops have been described in various publications. Further, various patents and patent applications describe genes and proteins that can be used to increase plant tolerance to abiotic stress. The application of chemical substances such as azole compounds, phytohormones or plant growth regulators have been shown to increase the tolerance of plants to abiotic stress. However, these chemical substances may present environmental risks.

The present disclosure overcomes previous shortcomings in the art by providing methods and compositions that increase the tolerance to stress in plants, compositions and methods being described as “natural” instead of, for example, using synthetically produced chemicals to achieve the desired results.

### BRIEF SUMMARY

The present invention provides a method for: reducing the effects of abiotic stress in a plant and/or a plant part; and/or increasing the tolerance to abiotic stress of a plant and/or a plant part; and/or increasing biomass or yield of a plant and/or a plant part under abiotic stress; wherein said method comprises contacting the plant and/or the plant part or soil with a composition comprising a yeast-derived material. Contacting the plant and/or the plant part or the soil with the composition comprising a yeast-derived material may thereby reduce the effects of abiotic stress in the plant and/or the plant part and/or increase the tolerance to abiotic stress of the plant and/or the plant part and/or increase biomass or yield of the plant and/or the plant part compared to an untreated plant and/or plant part.

The present invention further provides a method for reducing the effects of abiotic stress in a plant and/or a plant part, wherein said method comprises contacting the plant and/or the plant part or soil with a composition comprising a yeast-derived material. Contacting the plant and/or the plant part or the soil with the composition comprising a yeast-derived material may thereby reduce the effects of abiotic stress in the plant and/or the plant part compared to an untreated plant and/or plant part.

The present invention also provides a method for increasing the tolerance to abiotic stress of a plant and/or a plant part, wherein said method comprises contacting the plant and/or the plant part or soil with a composition comprising a yeast-derived material. Contacting the plant and/or the plant part or the soil with the composition comprising a yeast-derived material may thereby increase the tolerance to abiotic stress of the plant and/or the plant part compared to an untreated plant and/or plant part.

The present invention further provides a method for increasing biomass or yield of a plant and/or a plant part under abiotic stress, wherein said method comprises contacting the plant and/or the plant part or soil with a composition comprising a yeast-derived material. Contacting the plant and/or the plant part or the soil with the composition comprising a yeast-derived material may thereby increase biomass or yield of the plant and/or the plant part compared to an untreated plant and/or plant part.

Further provided by the present invention is the use of a yeast-derived material for: reducing the effects of abiotic stress in a plant and/or a plant part; and/or increasing the tolerance to abiotic stress of a plant and/or a plant part; and/or increasing biomass or yield of a plant and/or plant part, wherein said use comprises contacting the plant and/or the plant part or soil with a composition comprising a yeast-derived material. Contacting the plant and/or the plant part or the soil with the composition comprising a yeast-derived material may thereby reduce the effects of abiotic stress in the plant and/or the plant part and/or increase the tolerance to abiotic stress of the plant and/or the plant part and/or increase biomass or yield of the plant and/or the plant part compared to an untreated plant and/or plant part.

The present invention further provides the use of a yeast-derived material for reducing the effects of abiotic stress in a plant and/or a plant part, wherein said method comprises contacting the plant and/or the plant part or soil with a composition comprising a yeast-derived material. Contacting the plant and/or the plant part or the soil with the composition comprising a yeast-derived material may thereby reduce the effects of abiotic stress in the plant and/or the plant part compared to an untreated plant and/or plant part.

The present invention also provides the use of a yeast-derived material for increasing the tolerance to abiotic stress of a plant and/or a plant part, wherein said method comprises contacting the plant and/or the plant part or soil with a composition comprising a yeast-derived material. Contacting the plant and/or the plant part or the soil with the composition comprising a yeast-derived material may thereby increase the tolerance to abiotic stress of the plant and/or the plant part compared to an untreated plant and/or plant part.

The present invention further provides the use of a yeast-derived material increasing biomass or yield of a plant and/or a plant part under abiotic stress, wherein said method comprises contacting the plant and/or the plant part or soil with a composition comprising a yeast-derived material. Contacting the plant and/or the plant part or the soil with the composition comprising a yeast-derived material may thereby increase biomass or yield of the plant and/or the plant part compared to an untreated plant and/or plant part.

In any of the uses of the present invention, the yeast-derived material may be a yeast hydrolysate, an inactive yeast, a yeast autolysate, a yeast extract or yeast cell walls. Preferably, said yeast-derived material is a yeast hydrolysate. More preferably, the yeast hydrolysate is obtained through an enzymatic hydrolysis and/or an acid hydrolysis and/or an alkaline hydrolysis and/or a physical treatment and/or mechanical treatment. Still more preferably, the yeast hydrolysate is obtained by an alkaline hydrolysis method comprising the steps of (i) providing whole yeast cell material; and (ii) subjecting said whole yeast cell material to a chemical treatment with an alkali solution at a pH of above 8 and a temperature of above 45° C. to obtain a yeast hydrolysate. Said alkaline hydrolysis method may be carried out for sufficient time to allow the yeast alkaline hydrolysate to form, such as at least about 30 minutes, or at least about one hour, or for 1 to 20 hours. Said alkali solution may have a pH in the range of 8.5-14, or in the range of about 8.5-11.5. The temperature may be in the range of 50-120° C., or in the range of 60-110° C. Said yeast cell material is a whole yeast cell material.

In any of the methods or uses of the present invention, said method or use may further comprise separately, simultaneously or sequentially contacting the plant and/or the plant part with one or more additional agricultural compound. Said one or more additional agricultural compound may be proline.

In any of the methods or uses of the present invention, said yeast-derived material may be hydrolysate described herein and the said one or more additional agricultural compound may be proline. Said yeast hydrolysate and said proline may be contacted to the plant, plant part or soil at a percentage weight ratio from 80:20 to 20:80% w/w. Said yeast hydrolysate and said proline may be contacted to the plant, plant part or soil at a percentage weight ratio of about 75:25% w/w. Said yeast hydrolysate and said proline may be contacted to the plant, plant part or soil at a percentage weight ratio of about 50:50% w/w.

In any of the methods or uses of the present invention, said method or use may further comprise simultaneously contacting the plant and/or the plant part with one or more additional agricultural compound, wherein the one or more additional agricultural compound is provided in the composition comprising the yeast-derived material. Said one or more additional agricultural compound may be proline. Said yeast derived-material may be a yeast hydrolysate and said one or more additional agricultural compound may be proline. Said yeast hydrolysate and said proline may be provided in a composition at a percentage weight ratio from 80:20 to 20:80% w/w. Said yeast hydrolysate and said proline may be provided in a composition at a percentage weight ratio of about 75:25% w/w or about 50:50% w/w. Said yeast hydrolysate and said proline may be provided in a composition at a percentage weight ratio of about 50:50% w/w.

In any of the methods or uses of the present invention, the step of contacting the plant and/or the plant part or the soil with the composition comprising the yeast-derived material may be performed by applying the yeast-derived material in an amount of in an amount of at least 0.01 kg; 0.02 kg; 0.03 kg; 0.04 kg; 0.05 kg; 0.06 kg; 0.07 kg; 0.08 kg; 0.09 kg; 0.1 kg; 0.2 kg; 0.3 kg; 0.4 kg; 0.5 kg; 0.6 kg; 0.7 kg; 0.8 kg; 0.9 kg; 1 kg; 2 kg, 3 kg; 4 kg; 5 kg, 6 kg; 7 kg; 8 kg; 9 kg; 10 kg; 11 kg; 12 kg; 13 kg; 14 kg; 15 kg; 16 kg; 17 kg; 18 kg; 19 kg; 20 kg; 21 kg; 22 kg; 23 kg; 24 kg; 25 kg; 30 kg; 35 kg; 40 kg; 45 kg; 50 kg; 55 kg; 60 kg; 65 kg; 70 kg; 75 kg; 80 kg; 85 kg; 90 kg; 95 kg or more than 100 kg of dry matter per hectare.

The present invention also provides a composition for: reducing the effects of abiotic stress in a plant and/or a plant part; and/or increasing the tolerance to abiotic stress in a plant and/or a plant part; and/or increasing biomass or yield of a plant and/or plant part under abiotic stress, wherein said composition comprises a yeast-derived material as an active substance and an agriculturally acceptable carrier.

The present invention further provides a composition for reducing the effects of abiotic stress in a plant and/or a plant part, wherein said composition comprises a yeast-derived material as an active substance and an agriculturally acceptable carrier.

The present invention also provides a composition for increasing the tolerance to abiotic stress in a plant and/or a plant part, wherein said composition comprises a yeast-derived material as an active substance and an agriculturally acceptable carrier.

The present invention also provides a composition for increasing biomass or yield of a plant and/or plant part under abiotic stress wherein said composition comprises a yeast-derived material as an active substance and an agriculturally acceptable carrier.

In any of the methods, uses or compositions of the present invention, the yeast-derived material may be a yeast hydrolysate, an inactive yeast, a yeast autolysate, a yeast extract, yeast cell walls or yeast cell-wall derivatives. Preferably, said yeast-derived material is a yeast hydrolysate. Optionally, the yeast hydrolysate is obtained through an alkaline hydrolysis and/or an enzymatic hydrolysis and/or an acid hydrolysis and/or a physical treatment and/or mechanical treatment.

In any of the methods, uses or compositions of the present invention, the yeast-derived material may be a yeast alkaline hydrolysate. Preferably, the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate. Said alkaline hydrolysis method may be carried out for sufficient time to allow the yeast alkaline hydrolysate to form, such as at least about 30 minutes, or at least about one hour, or for 1 to 20 hours. Said alkali solution may have a pH in the range of 8.5-14, or in the range of about 8.5-11.5. The temperature may be in the range of 50-120° C., or in the range of 60-110° C. Said yeast cell material may be a whole yeast cell material.

In any of the methods, uses or compositions of the present invention, the yeast of the yeast-derived material may be a species from the genera Saccharomyces, Kluyveromyces, Hanseniaspora, Metschnikowia, Pichia, Starmerella, Torulaspora, Brettanomyces, Lachancea, Schizosaccharomyces or Candida. Preferably, the yeast of the yeast-derived material is from the genus Saccharomyces. More preferably, the yeast of the yeast-derived material is S. cerevisiae.

In any of the methods, uses or compositions of the present invention, the composition may further comprise an agriculturally acceptable carrier.

In any of the methods, uses or compositions of the present invention, the composition may further comprise one or more additional agricultural compound. The one or more additional agricultural compound may be proline.

In any of the compositions of the present invention, the composition may comprise a yeast hydrolysate described herein and proline. The yeast hydrolysate and the proline may be provided in the composition at a percentage weight ratio from 80:20 to 20:80% w/w. The yeast hydrolysate and the proline may be provided in the composition at a percentage weight ratio of about 75:25% w/w. The yeast hydrolysate and the proline may be provided in the composition at a percentage weight ratio of about 50:50% w/w.

The present invention further provides a yeast hydrolysate intended to be used for: reducing the effects of abiotic stress in a plant and/or a plant part; and/or increasing the tolerance to abiotic stress in a plant and/or a plant part; and/or increasing biomass or yield of a plant and/or plant part under abiotic stress.

The present invention further provides a yeast hydrolysate intended to be used for reducing the effects of abiotic stress in a plant and/or a plant part.

The present invention also provides a yeast hydrolysate intended to be used for increasing the tolerance to abiotic stress in a plant and/or a plant part.

The present invention further provides a yeast hydrolysate intended to be used for increasing biomass or yield of a plant and/or plant part under abiotic stress.

The yeast hydrolysate of the present invention may be obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate. Said alkaline hydrolysis method may be carried out for sufficient time to allow the yeast alkaline hydrolysate to form, such as at least about 30 minutes, or at least about one hour, or for 1 to 20 hours. Said alkali solution may have a pH in the range of 8.5-14, or in the range of about 8.5-11.5. The temperature may be in the range of 50-120° C., or in the range of 60-110° C. Said yeast cell material may be a whole yeast cell material.

The yeast hydrolysate of the present invention may be derived from a yeast of a species from the genera Saccharomyces, Kluyveromyces, Hanseniaspora, Metschnikowia, Pichia, Starmerella, Torulaspora, Brettanomyces, Lachancea, Schizosaccharomyces or Candida. Preferably, the yeast hydrolysate of the invention is derived from a yeast from the genus Saccharomyces. More preferably, the yeast hydrolysate of the present invention is derived from S. cerevisiae.

In any of the methods, uses, compositions or yeast hydrolysates of the present invention, said abiotic stress may be high temperature, heat, drought, water stress, high light intensity, hail, cold temperature, freezing, chilling, salinity, ozone, or combinations thereof. Preferably, said abiotic stress is high temperature, drought, water stress, high light intensity and/or hail.

In any of the methods, uses, compositions or yeast hydrolysates of the present invention, said plant may be a vine and/or said plant part may be a part of a vine.

### FIGURES

Having thus generally described the nature of the invention, reference will now be made to the accompanying drawings, showing by way of illustration, a preferred embodiment thereof, and in which:

FIG. 1 illustrates maximum air temperature (° C.) and precipitation (mm) for the period covering the experiment.

FIGS. 2A and D illustrate the net photosynthesis (P); B and E illustrate the stomatal conductance (gₛ) and C and F illustrate the water use efficiency (WUE) in seven-year-old Sangiovese vines treated with T1 (yeast hydrolysate) and T2 (yeast hydrolysate combined with proline) compared to a non-treated control under well-watered (WW) and water-stress (WS) conditions. Data show mean±S.E. * indicates a significant difference between treatments (p<0.05).

FIG. 3 illustrates the stem water potential in seven-year-old Sangiovese vines treated with T1 (yeast hydrolysate) and T2 (yeast hydrolysate combined with proline) compared to a non-treated control under well-watered (WW) and water-stress (WS) conditions. Data show mean±S.E. * indicates a significant difference between treatments (p<0.05).

FIGS. 4A and D illustrate the photochemical efficiency of PSII (Fᵥ/Fₘ); B and E illustrate the size of the plastoquinone pool (area); and C and F illustrate the chlorophyll content (SPAD units) in seven-year-old Sangiovese vines treated with T1 (yeast hydrolysate) and T2 (yeast hydrolysate combined with proline) compared to a non-treated control under well-watered (WW) and water-stress (WS) conditions. Data show mean±S.E. * indicates a significant difference between treatments (p<0.05).

FIG. 5 illustrates the evolution of midday leaf water potential during the experiment according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12).

FIG. 6 illustrates the leaf photosynthetic rates (A) during the experiments according to tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12).

FIG. 7 illustrates the leaf transpiration rates (E) during the experiments according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12).

FIG. 8 illustrates the PSII maximum quantum yield (Fv/Fm) during the experiment according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12).

FIG. 9 illustrates leaf thermal status on DOY 202 (A) and 209 (B) according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12). Different letters indicate significant difference per P<0.05.

FIG. 10 illustrates the canopy thermal status on DOY 202 (A) and 209 (B) according to different treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12). Different letters indicate significant difference per P<0.05.

FIG. 11 illustrates the bunch thermal status on DOY 202 (A) and 209 (B) according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12). Different letters indicate significant difference per P<0.05.

FIG. 12 illustrates leaf soluble sugars (A) and starch concentration during the experiment according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=4).

FIG. 13 illustrates the leaf proline concentration during the experiment according to tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=4)

FIG. 14 illustrates the evolution the incidence of sunburn on the grapes during ripening according to different tested treatments: T1 (yeast hydrolysate); T2 (75% w/w of the yeast hydrolysate and 25% w/w of proline) and T3 (50% w/w of the yeast hydrolysate and 50% of proline w/w). Means ±standard errors (n=12).

FIG. 15 illustrates the evolution of grapes sunburn spread during ripening according to different tested treatments: T1 (yeast hydrolysate); T2 (75% w/w of the yeast hydrolysate and 25% w/w of proline) and T3 (50% w/w of the yeast hydrolysate and 50% of proline w/w). The McKinney index integrates incidence and severity. Means ±standard errors (n=12). Different letters indicate significant differences per P<0.05 (SNK test).

FIG. 16 illustrates the correlation between berries affected by sunburn (%) and berry weight.

FIG. 17 illustrates the correlation between berry weight and grapes total soluble solids (TSS).

FIG. 18 illustrates the correlation between berries affected by sunburn (%) and grapes total soluble solids (TSS).

FIG. 19 illustrates the yield recovery (kg/vine) after hail damages.

FIG. 20 illustrates the total leaf area dynamics over the experimental period in well-watered (WW) (A) and water stress (WS) (B) conditions.

FIG. 21 illustrates the expression of abscisic acid (ABA) biosynthesis (as indicated using the expression of NCED3 (Nine-cis-epoxycarotenoid cleavage dioxygenase) as a proxy) and response (RAB18: Response to ABA 18; RD29B (Response to Desiccation 29B, homologous to RD29A)) genes with respect to the reference sample for which expression was set to 1. Ubiquitin 10 was used as a reference gene.

FIG. 22 illustrates the leaf photosynthetic rates (A) in well-watered (WW) and water-stressed (WS) vines subjected to multiple foliar application of 75% w/w of a yeast hydrolysate in combination with 25% w/w of proline (T), or unsprayed controls (C).

FIG. 23 illustrates the leaf transpiration rates (E) in well-watered (WW) and water-stressed (WS) vines subjected to multiple foliar application of 75% w/w of a yeast hydrolysate in combination with 25% w/w of proline (T), or unsprayed controls (C).

FIG. 24 illustrates the water use efficiency (WUE) in well-watered (WW) and water-stressed (WS) vines subjected to foliar application of 75% w/w of a yeast hydrolysate in combination with 25% w/w of proline (T), or unsprayed controls (C).

FIG. 25 illustrates the leaf Fv/Fm in well-watered (WW) and water-stressed (WS) vines subjected to foliar application of 75% w/w of a yeast hydrolysate in combination with 25% w/w of proline (T), or unsprayed controls (C).

FIG. 26 illustrates the leaf proline concentration in water-stressed (WS) vines subjected to foliar application of 75% w/w of a yeast hydrolysate in combination with 25% w/w of proline (T), or unsprayed controls (C).

### GENERAL DEFINITIONS

In the following description and examples, a number of terms are used. In order to provide a clear and consistent understanding of the specification and claims, including the scope to be given to such terms, the following definitions are provided. Unless otherwise defined herein, all technical and scientific terms used have the same meaning as commonly understood by one of ordinary skill in the art to which this invention belongs. The disclosures of all publications, patent applications, patents and other references are incorporated herein in their entirety by reference.

The terms “comprising” or “to comprise” and their conjugations, as used herein, refer to a situation wherein said terms are used in their non-limiting sense to mean that items following the word are included, but items not specifically mentioned are not excluded. It also encompasses the more limiting verb “to consist essentially of” and “to consist of”.

Reference to an element by the indefinite article “a” or “an” does not exclude the possibility that more than one of the elements is present, unless the context clearly requires that there be one and only one of the elements. The indefinite article “a” or “an” thus usually means “at least one”.

The term “yeast-derived material” as used herein refers to a material comprising, containing or derived from yeasts. In particular, the term “yeast-derived material” is used to mean intact or ruptured cells and/or a cell fraction of yeasts. Examples of “yeast-derived material” are inactive yeasts (or inactivated yeasts or dead yeast), yeast autolysates, yeast hydrolysates, yeast extracts, yeast cell walls or yeast-cell wall derivatives (such as, for example, beta-glucans, chitin and mannans). By “intact cells” is meant that the cell envelope (i.e. the cell wall, periplasm and plasma membrane) of the majority of the yeast cells is largely intact; preferably the cell envelope remains largely intact on at least 50%, and especially on at least 75% or at least 90%, of the yeast cells in the substance. The term “intact cells” may be used to describe cells that have been treated to weaken or partially remove the cell envelope, e.g. with lytic enzymes, but preferably refers to cells which have not been so treated. By “ruptured yeast cells” is meant a material comprising essentially all of the constituents of the intact yeast cells but wherein the cell wall of the majority of the yeast cells is largely broken (e.g. the cells have been lysed); preferably the cell wall has been broken on at least 50%, and especially on at least 75% or at least 90%, of the yeast cells in the substance. By “cell fraction” is meant an isolated part of the yeast cell. Examples of cell fractions include cell wall material and yeast extract.

The term “hydrolysis” as used in the context of the present disclosure is defined as the enzymatic and non-enzymatic breakdown of yeast cells using, for example, endogenous and/or exogenous enzymes. The endogenous yeast enzymes may or may not be inactivated, for instance by a heat shock. Alternatively, the yeast cells may be treated chemically or mechanically.

“Yeast hydrolysate” is defined herein as the digest of yeast obtained by hydrolysis of yeast, such as by mechanical and/or thermal and/or chemical treatment and/or enzymatic hydrolysis using endogenous and/or exogenous enzymes. In the context of the present disclosure, the term “autolysis” of a yeast is defined as a process wherein degradation of the yeast cells and of the polymeric yeast material is at least partially effected by active native yeast enzymes (i.e., endogenous enzymes) released in the medium after (partially) damaging and/or disrupting the yeast cell wall. A “yeast hydrolysate” may be obtained by thermal and/or chemical treatment and/or enzymatic treatment and/or mechanical treatment as taught herein.

A “yeast hydrolysate” in the context of the present disclosure contains both soluble and insoluble components derived from the whole yeast cell. When the “yeast hydrolysate” contains both soluble and insoluble components derived from the whole yeast cell, the latter differs from a “yeast extract” because the yeast hydrolysate, in addition to all the interesting components present in yeast extracts, also contains interesting cell wall components (mainly composed of μ-glucans, mannoproteins, chitin and proteins) which are not separated from the soluble fraction. The term “yeast extract” refers to the content or the intracellular components of the yeast cells, with the yeast cell wall removed, said content being obtained by any suitable extraction process known to those skilled in the art. For example, the yeast extract can be obtained by autolysis or plasmolysis. The yeast extract refers to the soluble fraction. The “yeast cell walls” are obtained by separation of the envelope and the rest of the yeast cell. In other words, the “yeast cell wall” fraction or the insoluble fraction corresponds to the envelopes of the yeast cells excluding the contents of the cells, i.e. the intracellular components of the yeast cells. The “yeast hydrolysate” of the present disclosure can also be obtained from the insoluble fraction of the yeast, i.e. from the yeast cell walls. The yeast hydrolysate of the present disclosure can also include, comprise or consist or be yeast-cell wall derivatives isolated and purified from yeast cell walls derived from the whole yeast cell or only from yeast cell walls.

The term “stress” as used herein refers interchangeably to plant stress, plant stress factors, challenges, or growth challenges that prevent, impede, stop or halt plant growth from a normal rate of plant growth, a normal rate of production, productivity or yield, metabolism, reproduction and/or viability. The stress can be an abiotic stress.

The term “abiotic stress” as used herein refers to any adverse effect on metabolism, growth, reproduction and/or viability of a plant. These adverse effects refer to outside, non-living factors or to non-living substances or environmental factors which can cause one or more injuries to a plant and/or plant part. Accordingly, abiotic stress can be induced by suboptimal environmental growth conditions such as, for example, chilling, salinity, osmotic stress, water deprivation, drought, flooding, freezing, low or high temperature, heavy metal toxicity, anaerobiosis, atmospheric pollution, UV irradiation, hail or combination thereof. Parameters for abiotic stress factors are species specific and even variety specific and therefore vary widely according to the species/variety exposed to the abiotic stress. Thus, while one species may be severely impacted by a high temperature of 23° C., another species may not be impacted until at least 30° C., and the like. Temperatures above 30° C. result in dramatic reductions in the yields of most important crops. In addition, because most crops are exposed to multiple abiotic stresses at one time, the interaction between the stresses affects the response of the plant. Water stressed plants are less able to cool overheated tissues due to reduced transpiration, further exacerbating the impact of excess (high) heat and/or excess (high) light intensity. Thus, the particular parameters for high/low temperature, light intensity, drought and the like, which impact crop productivity will vary with species, variety, degree of acclimatization and the exposure to a combination of environmental conditions.

The phrase “abiotic stress tolerance” as used herein refers to the ability of a plant to withstand, tolerate or endure an abiotic stress without ongoing or suffering a substantial alteration in metabolism, growth, yield, productivity and/or viability.

As used herein, the terms “increase,” “increasing,” “increased,” “enhance,” “enhanced,” “enhancing,” and “enhancement” describe an elevation of at least about 0,2%; 0,3%; 0,4%; 0,5%; 0,6%; 0,7%; 0,8%; 0,9%; 1%; 2%; 3%; 4%; 5%; 6%; 7%; 8%; 9%; 10%; 11%; 12%; 13%; 14%; 15%; 16%; 17%; 18%; 19%; 20%; 25%; 30%; 35%; 40%; 45%; 50%; 55%; 60%; 65%. 70%; 75%, 80%; 85%; 90%; 95%; 100%; 110%; 120%; 130%; 140%; 150%; 160%; 170%; 180%; 190%; 200%, 210%; 220%; 230%; 240%; 250%; 260%; 270%; 280%; 290%; 300%; 310%; 320%; 330%; 340%; 350%; 360%; 370%; 380%;390%; 400%; 410%; 420%; 430%; 440%; 450%; 460%; 470%; 480%; 490%, 500% or more as compared to a control. In some embodiments, as used herein, these terms refer to an enhancement or augmentation of, for example, number, size and weight of fruits produced by a plant, yield, water use efficiency, photosynthesis rate, canopy development, leaf water potential, chlorophyll content and the like as a response to alleviating abiotic stress to which the plant is exposed. Thus, in some embodiments, a plant or plant part contacted with a composition(s) of the present disclosure may have increased tolerance to abiotic stress as compared to a plant or plant part that has not been contacted with the composition(s) of the present disclosure.

An “increased tolerance to abiotic stress” as used herein refers to the ability of a plant and/or part thereof exposed to abiotic stress and contacted with a composition(s) of the present disclosure to withstand a given abiotic stress better than a control plant and/or part thereof (i.e., a plant and/or part thereof that has been exposed to the same abiotic stress but has not been contacted with the composition(s) of the present disclosure). Increased tolerance to abiotic stress can be measured using a variety of parameters including, but not limited to, the size and/or number of plants or parts thereof, and the like (e.g., number, weight and/or size of fruits), water potential, photosynthesis rate, water use efficiency, severity of the sunburn, fruit quality, temperature of the bunches or fruits crop yield, and the like. Thus, in some embodiments of this disclosure, a plant and/or part thereof having been contacted with a composition(s) of the present disclosure and having increased tolerance to the abiotic stress, for example, would have an higher photosynthesis rate and water use efficiency as compared to a plant and/or part thereof exposed to the same stress but not having been contacted with the composition(s) of the present disclosure.

The term “consequence of abiotic stress” used here refers to the effects, results or outcome of exposing a plant and/or part of it to one or more abiotic stresses. Thus, a consequence of abiotic stress includes, but is not limited to, damage caused by sunburn, flower abortion, fruit drop, a reduction in the number of plants or plant parts, a reduction in product quality (e.g., fruit quality), yield reduction, a reduction in the size of plants or plant parts, etc measured in terms of physical and chemical parameters known to the person skilled in the art. The consequences of abiotic stress are generally those that have a negative impact on crop yield and quality.

The expression “reducing the consequences of abiotic stress”, as used herein, refers to the ability of a plant and/or part thereof exposed to abiotic stress and brought into contact with a composition(s) of the present disclosure to better resist a given abiotic stress than a control plant and/or part thereof (i.e. a plant and/or part thereof that has been exposed to the same abiotic stress but has not been brought into contact with the composition(s) of the present disclosure), which makes it possible to decrease or reduce the consequences of abiotic stress in the plant and/or part of it. The consequence of abiotic stress can be measured using a variety of parameters including, but not limited to, the size and/or number of plants or plant parts, and others (e.g. number and/or size of fruits), yield reduction and combinations thereof and measured in terms of physical and chemical parameters known to the person skilled in the art. Thus, reducing the consequences of abiotic stress as used here may also mean maintaining the size and number of plants and/or plant parts, and others (e.g. number, weight and/or size of fruits), water potential, photosynthesis rate, water use efficiency, temperature of the bunches or fruits other quality parameters (e.g. color, sugar content, appearance and/or shape of fruit), as observed in a control plant that was not exposed to abiotic stress.

As used herein, the term “plant biomass” refers to the amount of a tissue produced from the plant in a growing season, which could also determine or affect the plant yield or the yield per growing area. An increase in plant biomass can be in the whole plant or in parts thereof such as aboveground (harvestable) parts, vegetative biomass, roots and seeds. The “plant biomass” is often measured as the dry mass or weight (or “fresh weight” where appropriate) of the plant.

As used herein the term “plant yield” refers to the amount (e.g., as determined by weight or size) or quantity (numbers) of tissues or organs produced per plant or per growing season.

The term “increasing biomass and/or yield of a plant and/or plant part” as used in the present disclosure means at least 0,2%; 0,3%; 0,4%; 0,5%; 0,6%; 0,7%; 0,8%; 0,9%; 1%; 2%; 3%; 4%; 5%; 6%; 7%; 8%; 9%; 10%; 11%; 12%; 13%; 14%; 15%; 16%; 17%; 18%; 19%; 20%; 25%; 30%; 35%; 40%; 45%; 50% or more of yield and/or biomass of plant and/or plant part increase compared to control plants grown in the same conditions as those of the treated plants.

The term “enhancing recovery” as used in the present disclosure means that the plant is able to reverse the effects of the stress injury faster and more efficiently than a non-treated plant.

The term “contacting” a plant or a plant part or a soil as used in the present disclosure includes any method by which a composition(s) of the present disclosure is brought into contact with the plant and/or part thereof. The term “contact” comprises any method in which a plant is exposed to, provided with, or in which a composition is applied or comes into proximity to a plant and/or part thereof. Some non-limiting examples of contacting a plant and/or part thereof include spraying, dusting, sprinkling, scattering, misting, atomizing, broadcasting, soaking, soil injection, soil incorporation, drenching (e.g., soil treatment), pouring, coating, leaf or stem infiltration, side dressing or seed treatment, and the like, and combinations thereof. These and other procedures for contacting a plant and/or part thereof with compound(s), composition(s) or formulation(s) are well-known to those skilled in the art. The application forms and methods depend entirely on the intended purposes in order to ensure the finest and uniform distribution of the composition of the present disclosure onto the plant or plant part.

As used herein, the term “plant and/or plant part” refers to a whole live plant as well as any part, tissue or organ from a live plant. For example, the term “plant and/or plant part” includes fruit, flowers, tubers, roots, stems, hypocotyls, leaves, petioles, petals, seeds, etc. The plants of the present invention may be planted in the ground or soil, such as a field, garden, orchard, etc., or may be in a pot or other confined growing apparatus.

As used herein, the term “simultaneously” means that the composition of the present disclosure and an additional compound are delivered to a plant and/or plant part at the same time or substantially at the same time via the same mode of application. As used herein, the term “separately” means that the composition of the present disclosure and an additional compound are delivered to a plant and/or plant part at the same time or substantially at the same time via a different mode of application. As used herein, the term “sequentially” means that the composition of the present disclosure and an additional compound are delivered to a plant and/or plant part at different times (i.e. the composition or the present disclosure can be before or after the other compound), the mode of application being identical or different.

### DETAILED DESCRIPTION

The present disclosure concerns the use of a yeast-derived material (such as a yeast hydrolysate) as an active ingredient for increasing tolerance to stress (such as an abiotic stress) and/or for reducing the consequence of stress in a plant and/or a plant part thereof as compared to a control plant that has not been contacted with the yeast-derived material of the present disclosure. The use of the yeast-derived material allows, amongst other, to a better adaptation of the plants to the different abiotic stress factors. The yeast-derived material of the present disclosure results, amongst other, in limiting the negative effects of abiotic stress factors on plant growth, plant yield, plant biomass and fruit quality. Also, it has been demonstrated that the yeast-derived material of the present disclosure favors the recovery of the plant once the abiotic stress factors mitigate.

Accordingly, in some embodiments, the present disclosure provides a method for increasing tolerance to stress and/or for reducing the consequence of stress in a plant and/or plant part thereof, comprising contacting a plant and/or part thereof or soil with a yeast-derived material thereby increasing tolerance to stress and/or for reducing the consequence of stress in a plant and/or part thereof as compared to a control plant that has not been contacted with the composition of the present disclosure.

In an another embodiment, the present disclosure provides a method for increasing tolerance to abiotic stress and/or for reducing the consequence of abiotic stress in a plant and/or part thereof, comprising contacting a plant and/or part thereof or soil with a yeast-derived material thereby increasing tolerance to abiotic stress and/or for reducing the consequence of abiotic stress in a plant and/or part thereof as compared to a control plant that has not been contacted with the composition of the present disclosure.

In an embodiment, the present disclosure provides a method for increasing biomass or yield of a plant and/or plant part comprising contacting a plant and/or part thereof or soil with a yeast-derived material (such as a yeast hydrolysate) thereby increasing tolerance to abiotic stress and/or for reducing the consequence of abiotic stress in a plant and/or part thereof or increasing biomass or yield of a plant and/or plant part as compared to a control plant that has not been contacted with the yeast-derived material (such as a yeast hydrolysate) of the present disclosure.

The yeast-derived material of the present disclosure can be made using many yeast strains, including yeast strains of the genus Saccharomyces like wine and beer yeast strains, baker's yeast strains and probiotic yeast strains. Other suitable yeast strains include non-Saccharomyces genus, as for example, but not limited to Kluyveromyces, Hanseniaspora, Metschnikowia, Pichia, Starmerella, Torulaspora, Candida, Brettanomyces, Schizosaccharomyces or Lachancea. The yeast hydrolysate can be produced from both liquid and dry yeast (e.g., active dry yeast powder). In a preferred embodiment, the yeast-derived material of the present disclosure is made using a strain of Saccharomyces cerevisiae or Saccharomyces cerevisiae var boulardii. Yeast can be from primary grown as well as spent yeast from fermentation processes (e.g. spent brewer's yeast).

In one embodiment, the yeast-derived material is inactive yeasts, yeast autolysates, yeast hydrolysates, yeast extracts or yeast cell walls. In an embodiment, the yeast-derived material for use in the context of the present disclosure is a yeast hydrolysate or a yeast autolysate. Methods for the hydrolysis or autolysis of yeast cells are well known in the art. In an embodiment, the yeast-derived material for use in the context of the present disclosure is a yeast hydrolysate. In an embodiment, the yeast hydrolysate includes, comprises or contains yeast-cell wall derivatives or isolated or purified yeast-cell wall derivatives.

For example, the yeast hydrolysate of the present disclosure may be any yeast product obtained from yeast cells using any type of hydrolysis. The yeast hydrolysate of the present disclosure can be obtained through enzymatic hydrolysis and/or acid hydrolysis and/or alkaline hydrolysis and/or a physical treatment and/or mechanical treatment.

The acid hydrolysis is a hydrolysis obtained in an acidic medium, preferably in the heat, for example by using a strong acid such as hydrochloric acid, sulphuric acid, phosphoric acid, and/or nitric acid.

The alkaline hydrolysis is a hydrolysis obtained in an alkaline medium, for example by using a strong base such as sodium hydroxide, potassium hydroxide or any known base used in the art.

The enzymatic hydrolysis of the yeast proteins is carried out through hydrolases. The enzymatic hydrolysis is carried out by adding at least one exogenous enzyme. Preferably, the yeast exogenous enzymes have been deactivated beforehand, for example through a thermal treatment.

Mechanical treatments are known to the skilled person in the art and include, for example, bead mill, high pressure, homogenization or ultrasonic.

In a suitable embodiment, the yeast hydrolysate is obtained by high temperature and/or alkaline treatment of yeast cells and is referred to as being a yeast hydrolysate or a yeast alkaline hydrolysate. The yeast hydrolysate can be obtained from both soluble and insoluble components (e.g. fractions) derived from the yeast cell material or, alternatively, can be obtained from insoluble components (e.g. fractions) derived from the yeast cell material. In one embodiment, the yeast hydrolysate is produced from a whole yeast cells or whole yeast cell material and comprises both soluble and insoluble components derived from the yeast material.

The yeast hydrolysate may be in any form, e.g., a liquid form or in the form of a dry powder.

In an embodiment, the yeast hydrolysate is obtained by an alkaline hydrolysis method. For example, the yeast hydrolysate is obtained by an alkaline hydrolysis method comprising the steps of:
i. providing yeast cell material; and
ii. subjecting said yeast cell material to a chemical treatment with an alkali solution at a pH of above 8 and a temperature of above 45° C. Such yeast hydrolysate can also be called a “yeast alkaline hydrolysate”.

The yeast cell material may be any yeast cell material (i.e. whole yeast cells (i.e. soluble and insoluble fractions) or yeast cell walls (i.e. insoluble fraction). In an embodiment, they yeast cell material is whole yeast cells. For example, the method for the production of yeast hydrolysate from yeast biomass may start with an aqueous suspension of yeast cells such as a fermentation broth comprising yeast cells, in which case such aqueous suspension may qualify as yeast cell material. Fermentation processes suitable to produce suspensions of yeast cells are well-known in the art. In some cases, the fermentation broth may be removed from the yeast cells followed by concentration prior to its use in the hydrolysis method of the present disclosure, for example, by centrifugation or filtration to yield a yeast cream (i.e. a yeast material comprising whole yeast cells).

Suitably, the hydrolysis methods taught herein may be initiated by breaking and/or rupturing the yeast cell walls of the yeast cell material. The content of the cells, in part or entirely, may then be released via the partial openings created by the disruption of the yeast cell walls. In addition to alkaline treatment, in order to break or rupture or disrupt the yeast cell walls, the yeast cells can be treated mechanically, chemically or enzymatically according to methods well known in the art.

Mechanical treatments include homogenization techniques. At this purpose, use of high-pressure homogenizers is possible. Other homogenization techniques may include mixing with particles, e.g. sand and/or glass beads, or the use of a milling apparatus (e.g. a bead mill).

The yeast hydrolysate taught herein may be produced by chemical treatments which include the use of salts, alkali and/or one or more surfactants or detergents. In an embodiment, the yeast cells are heated and alkali treated. For example, the chemical treatment may be performed at a temperature of 45 to 130° C., under alkaline conditions (pH 7.0 to 14.0) for sufficient time to allow the yeast alkaline hydrolysate to form.

The temperature in the method taught herein may, for example, be between 45 and 130° C., such as between 50 and 120° C., between 60 and 110° C. or between 70 and 100° C. In an embodiment, the temperature is above 60° C. The pH is preferably alkaline, i.e., in the range of 7.0 to 14.0. In an embodiment, the pH is above pH 7, more preferably above pH 8. The chemical treatment may be performed for sufficient time to allow the yeast alkaline hydrolysate to form, e.g., any time between 0.25 to 40 hours, such as between 0.5 to 30 hours, or between 1 to 20 hours. In an embodiment, the chemical treatment is performed for more than 2 hours.

In an embodiment, the chemical treatment is performed at a temperature of 60 to 110° C., under alkaline condition at a pH 8 to 12, for 1 to 20 hours. In a further embodiment, the chemical treatment is performed at a temperature of 70 to 100° C., under alkaline condition at a pH above 8.5 for 1 to 20 hours.

Any alkaline solution known in the art can be used. For example, the alkaline agent can be calcium hydroxide (Ca(OH)₂), calcium oxide (CaO), ammonia (NH₃), sodium hydroxide (NaOH), sodium carbonate (NaCO₃), potassium hydroxide (KOH), urea, and/or combinations thereof.

The yeast-derived material described in the present disclosure can be formulated according to methods known to those skilled in the art. For example, the yeast hydrolysate obtained by the methods taught herein, being an aqueous suspension, may be centrifuged and/or filtered by means of micro- or ultrafiltration techniques. It is also possible to concentrate the aqueous suspension by evaporation. The resultant suspension may be dried into powder according to any suitable manners known in the art such as spray drying, roller drying, freeze drying, fluidized bed drying or a combination of these methods. In an embodiment, the resultant suspension is dried into powder by roller or spray drying.

In an embodiment, the yeast-derived material such as the yeast hydrolysate of the present disclosure is made from a yeast of the genus Saccharomyces. In an embodiment, the yeast species used is Saccharomyces cerevisiae.

The yeast-derived material of the present disclosure may further comprise an agricultural acceptable carrier or may be used as is. An agriculturally acceptable carrier of the present disclosure can include natural or synthetic, organic or inorganic material which is combined with the yeast-derived material of the present disclosure to facilitate its application to the plant and/or part thereof or soil. In some embodiments, an agriculturally-acceptable carrier of the present disclosure can include, but is not limited to, a support, filler, dispersant, emulsifier, wetter, adjuvant, solubilizer, colorant, tackifier, binder, anti-foaming agent and/or surfactant, or combinations thereof, that can be used in agricultural formulations. Suitable agriculturally acceptable carriers contemplated in the present disclosure are well known to the person skilled in the art.

The compositions of the present disclosure can be made in any formulation suitable for applying to or contacting with a plant and/or part thereof or soil. Formulations suitable for contacting the compositions of the disclosure to a plant and/or part thereof or soil include, but are not limited to, a spray, a suspension, a powder, a granule, a tablet, an extruded granule, a mist, an aerosol, a foam, paste, emulsions (e.g., in oil (vegetable or mineral), or water or oil/water), a capsule, and combinations thereof.

The composition or yeast-derived material of the present disclosure can be applied to a plant and/or plant part thereof or soil any time before or after the time that the plant and/or plant part is exposed to a stress such as an abiotic stress. In an embodiment, the composition of the present disclosure can be applied to a plant and/or plant part thereof or soil any time before to the time that the plant and/or plant part is exposed to a stress such as an abiotic stress. In one embodiment, the contacting step is repeated (e.g., more than once, as in the contacting step is repeated twice, three times, four times, five times, six times, etc.). The frequency of contacting a plant and/or part thereof or soil with a composition of the present disclosure can be as often as necessary to impart the desired effect of increasing tolerance to stress (e.g. abiotic stress), and/or reducing the consequence of stress (e.g. abiotic stress). The contacting step can be performed by any known method in the art. In some embodiments, the contacting step is repeated (e.g. more than once) and a composition of the present disclosure may be contacted with a plant and/or part thereof once, twice, three times, four times, five times, six times, seven times, eight times, nine times, ten times, 11 times, 12 times, 13 times, 14 times, 15 times, 16 times, 17 times, 18 times, 19 times, 20 times or more per season. Accordingly, as one of skill in the art would recognize, the amount and frequency of application or contacting of the compositions of the present disclosure to a plant and/or part thereof or soil will vary depending on the plant/crop type, the condition of the plant/crop, the stress (i.e. abiotic stress) or consequences thereof being alleviated and the like. As one of skill in the art would additionally recognize based on the description provided herein, a composition of the present disclosure can be effective for increasing tolerance to abiotic stress and/or reducing the consequence of abiotic stress in a plant and/or part thereof regardless of whether the initial application of the composition of the present disclosure is applied to the plant prior to, during, and/or after the initiation of the stress(es) (i.e. abiotic stress(es)).

In some embodiments, a plant and/or part thereof may be contacted with the composition yeast-derived material of the present disclosure during different stages of development of the plant and/or plant part. Non-limiting examples of different stages of development may include a seed, seedling, adult or mature plant, budding plant, flowering plant, and/or fruiting plant. A plant may be contacted with a composition(s) of the present disclosure at all stages of plant development. As would be well understood in the art, the stage or stages of development during which a composition(s) of the present disclosure may be contacted with the composition(s) of the present disclosure would depend upon the species of plant, the plant part and the stress to which the plant and/or part thereof is exposed. Thus, for example, an annual plant may be contacted upon the seedling stage with the composition of the present disclosure while perennial plants may be treated at any time during the vegetative phase, i.e. once root activity begins.

As discussed above, stress (i.e. abiotic stress) includes, but is not limited to, cold temperature, freezing, chilling, heat or high temperature, drought (i.e. water stress), high light intensity, salinity, ozone, hail and other weather hazards and/or combinations thereof. In some particular embodiments of the present disclosure, the stress (i.e. abiotic stress) is heat (or thermal stress or high temperature). In another embodiment, the stress is drought (or desiccation or dehydration stress or water stress). In an embodiment, the stress is a water stress. In still another embodiment, the abiotic stress is high light intensity. As one of skill in the art would recognize, at any one time, a plant may be exposed to one or more abiotic stresses. Thus, in some embodiments of the invention, the term abiotic stress refers to a combination of stresses. Such combinations of stresses include, but are not limited to, high light intensity and high temperature; high light intensity and drought; high light intensity and salinity; high temperature and salinity; drought and high temperature; high light intensity, high temperature, and drought; high light intensity, high temperature, and salinity; high light intensity, high temperature, salinity and drought; and the like. In some particular embodiments, a combination of abiotic stresses may be high temperature and high light intensity. In some embodiments, a combination of abiotic stresses may be high temperature, high light intensity and drought. In an embodiment, the abiotic stress is hail.

The methods of the present disclosure are useful for any type of plant and/or part thereof exposed to or which may become exposed to a stress such as an abiotic stress. Non-limiting examples of types of plants useful with this invention include woody, herbaceous, horticultural, agricultural, forestry, nursery, ornamental plant species and plant species useful in the production of biofuels, and combinations thereof. In some embodiments, a plant and/or part thereof useful with the invention includes, but is not limited to, Arabidopsis, vines, apple, tomato, pear, pepper (Capsicum), bean (e.g., green and dried), cucurbits (e.g., squash, cucumber, honeydew melon, watermelon, cantaloupe, and the like), papaya, mango, pineapple, avocado, stone fruits (e.g., plum, cherry, peach, apricot, nectarine, and the like), grape (wine and table), strawberry, raspberry, blueberry, mango, cranberry, gooseberry, banana, fig, citrus (e.g., clementine, kumquat, orange, grapefruit, tangerine, mandarin, lemon, lime, and the like), nuts (e.g., hazelnut, pistachio, walnut, macadamia, almond, pecan, and the like), lychee (Litchi), soybeans, corn, sugar cane, camelina, peanuts, cotton, canola, oilseed rape, sunflower, rapeseed, alfalfa, timothy, tobacco, tomato, sugarbeet, potato, pea, carrot, cereals (e.g., wheat, rice, barley, rye, millet, sorghum, oat, triticale, and the like), buckwheat, quinoa, turf, lettuce, roses, tulips, violets, basil, oil palm, elm, ash, oak, maple, fir, spruce, cedar, pine, birch, cypress, coffee, miscanthus, arundo, switchgrass, cocoa and combinations thereof. In an embodiment, the plant and/or plant part is vine.

The composition or yeast-derived material of the present disclosure comprising the yeast-derived material (such as a yeast hydrolysate) can be applied to a plant and/or plant part thereof or soil in an amount of at least 0.01 kg to 50 kg; 0.1 kg to 45 kg; 0.1 kg to 40 kg; 0.1 kg to 35 kg; 0.1 kg to 30 kg; 0,1 to 25 kg; 0.1 kg to 20 kg; 0.1 kg to 15 kg; 0.1 kg to 10 kg; or 0.1 kg to 5 kg of dry matter per hectare (and by application). In yet another embodiment, the composition of the present disclosure can be applied to a plant and/or plant part thereof or soil in an amount of at least 0.5 kg to 25 kg; 0.5 kg to 20 kg; 0.5 kg to 15 kg; 0.5 kg to 10 kg; or 0,5 to 5 kg of dry matter per hectare (and by application). In still another embodiment, composition of the present disclosure can be applied to a plant and/or plant part thereof or soil in an amount of at least 0.01 kg; 0.05 kg; 0.1 kg; 0.2 kg; 0.3 kg; 0.4 kg; 0.5 kg; 0.6 kg; 0.7 kg; 0.8 kg; 0.9 kg; 1 kg; 2 kg, 3 kg; 4 kg; 5 kg, 6 kg; 7 kg; 8 kg; 9 kg; 10 kg; 11 kg; 12 kg; 13 kg; 14 kg; 15 kg; 16 kg; 17 kg; 18 kg; 19 kg; 20 kg; 21 kg; 22 kg; 23 kg; 24 kg; 25 kg; 30 kg; 35 kg; 40 kg; 45 kg; 50 kg; 55 kg; 60 kg; 65 kg; 70 kg; 75 kg; 80 kg; 85 kg; 90 kg; 95 kg or more than 100 kg of dry matter per hectare (and by application).

The methods or compositions comprising the yeast-derived material (such as a yeast hydrolysate) of the present disclosure may be combined with exogenous proline and/or agricultural compounds. As known to the person skilled in the art, besides proline, other agricultural compounds such as fertilizers, biostimulants, herbicides, insecticides, fungicides or mineral solutions can be used. In an embodiment, the yeast hydrolysate and proline can be delivered simultaneously, sequentially or separately from each other to a plant and/or a plant part.

In an embodiment, when exogenous proline is used in combination with the composition of the present disclosure, the concentration of proline as applied to a plant and/or plant part thereof or soil may be about at least 0.01 kg; 0.05 kg; 0.1 kg; 0.2 kg; 0.3 kg; 0.4 kg; 0.5 kg; 0.6 kg; 0.7 kg; 0.8 kg; 0.9 kg; 1 kg; 2 kg, 3 kg; 4 kg; 5 kg, 6 kg; 7 kg; 8 kg; 9 kg; 10 kg; 11 kg; 12 kg; 13 kg; 14 kg; 15 kg; 16 kg; 17 kg; 18 kg; 19 kg; 20 kg; 21 kg; 22 kg; 23 kg; 24 kg; 25 kg; 30 kg; 35 kg; 40 kg; 45 kg; 50 kg; 55 kg; 60 kg; 65 kg; 70 kg; 75 kg; 80 kg; 85 kg; 90 kg; 95 kg or more than 100 kg of dry matter per hectare (and by application). The percentage weight ratio of the amount of the composition comprising the yeast-derived material (such as a yeast hydrolysate) of the present disclosure and the amount of exogenous proline as applied to a plant and/or plant part lies typically in the range of at least 99:1 (% weight/weight; % w/w); 98:2; 97:3; 96:4; 95:5; 90:10; 85:15; 80:20; 75:25; 70:30; 65:35; 60:40; 55:45; 50:50; 45:55; 40:60; 35:65; 30:70; 25:75; 20:80; 15:85; 10:90; 5:95; 4:96; 3:97; 2:98 or 1:99.

Suitably, the percentage weight ratio of yeast hydrolysate to proline may be from 95:5 to 5:95% w/w; from 90:10 to 10:90% w/w, from 80:20 to 80:20% w/w; from 75:25 to 25:75% w/w; from 75:25 to 40:60% w/w, from 75:25 to 45:55% w/w; or from 75:25 to 50:50% w/w.

The percentage weight ratio of yeast hydrolysate to proline may be about 75:25% w/w.

The percentage weight ratio of yeast hydrolysate to proline may be about 50:50% w/w.

As may be appreciated from the above description, the composition comprising the yeast-derived material (such as a yeast hydrolysate) and method of the present disclosure allows to enhance plant growth, plant yield and/or fruit quality in face of various abiotic stress factors including high light intensity, high temperature, salinity, drought or hail.

Additionally, the composition comprising the yeast-derived material (such as a yeast hydrolysate) and method of the present disclosure can be applied to a plant and/or plant part thereof or soil which has been exposed to a stress injury in order to accelerate the recovery of injured plant and/or plant part. The composition of the present disclosure can be applied to a plant and/or plant part any time before or after injury has occurred. In an embodiment, the composition of the present disclosure is applied to the plant and/or plant part immediately after the injury of the plant occurs. The present disclosure provides a method for accelerating the recovery of injured plant and/or plant part, comprising contacting a plant and/or part thereof with the composition of the present disclosure thereby accelerating the recovery of injured plant and/or plant part thereof as compared to a control plant that has not been contacted with the composition of the present disclosure. In an embodiment, the injury is caused by hail.

The present disclosure provides a method for increasing tolerance to water stress or drought and/or for reducing the consequence of to water stress or drought in a plant and/or part thereof, comprising contacting a plant and/or part thereof or soil with the composition of the present disclosure comprising the yeast-derived material (such as a yeast hydrolysate) thereby increasing tolerance to water stress or drought and/or for reducing the consequence of to water stress or drought in a plant and/or part thereof as compared to a control plant that has not been contacted with the composition of the present disclosure.

In an embodiment, the present disclosure provides a method for increasing tolerance to high temperature in a plant and/or part thereof, comprising contacting a plant and/or part thereof or soil with the composition of the present disclosure comprising the yeast-derived material (such as a yeast hydrolysate) thereby increasing tolerance to high temperature and reducing sunburn damages in a plant and/or part thereof as compared to a control plant that has not been contacted with the composition of the present disclosure.

In an embodiment, the present disclosure provides a method for increasing tolerance to high temperature, high light intensity and drought in a plant and/or part thereof, comprising contacting a plant and/or part thereof or soil with the composition comprising the yeast-derived material (such as a yeast hydrolysate) of the present disclosure thereby increasing tolerance to high temperature, high light intensity and drought in a plant and/or part thereof as compared to a control plant that has not been contacted with the composition of the present disclosure.

In an embodiment, the present disclosure provides a method for increasing tolerance to high temperature and drought in a plant and/or part thereof, comprising contacting a plant and/or part thereof or soil with the composition of the present disclosure comprising the yeast-derived material (such as a yeast hydrolysate) thereby increasing tolerance to high temperature and drought in a plant and/or part thereof as compared to a control plant that has not been contacted with the composition of the present disclosure.

In an embodiment, the present disclosure provides a method for increasing tolerance to high light intensity and drought in a plant and/or part thereof, comprising contacting a plant and/or part thereof or soil with the composition comprising the yeast-derived material (such as a yeast hydrolysate) of the present disclosure thereby increasing tolerance to high light intensity and drought in a plant and/or part thereof as compared to a control plant that has not been contacted with the composition of the present disclosure.

As may be appreciated from the present description, the method of the present disclosure allows the enhancement of plant biomass, plant yield and/or fruit weight in face of various plant growth challenges or stress factors, as for example, abiotic stresses such as water stress, drought, high temperature, high light intensity or hail.

The following example serves to further describe and define the invention and is not intended to limit the invention in any way.

### Example 1: Preparation of the Yeast Hydrolysate of the Present Disclosure

Industrial cream yeast (20% of dry matter) comprising whole yeast cells from a wine yeast strain of Saccharomyces cerevisiae (Lallemand) was obtained and subjected to a treatment with NaOH to adjust the pH between 8 to 11. The mixture was incubated during at least 2 hours at a temperature of between 70° C. to 90° C. The resulting hydrolysate was then dried by roller into powder (>95% of dry matter).

### Example 2: Effects of the Yeast Hydrolysate in Vines (Cultivar Sangiovese) Under Summer stresses

Drought and high summer temperatures are the major abiotic stresses affecting modern and traditional viticultural regions around the world today as a consequence of global warming.

The objective of this study was to evaluate the effect of the application of yeast hydrolysate on physiology, yield and grape composition of Sangiovese vines grown in pots and subjected to thermal and water stress in summer.

### Materials and Methods

### Experimental Design

The study was conducted on thirty-seven-year-old vines cultivar Sangiovese (clone VCR30) grafted on 1103 Paulsen rootstock and grown outdoors in 60-liter pots.

The yeast hydrolysate was prepared by the method described in Example 1. Two treatments were applied: T1 yeast hydrolysate according to Example 1; and T2 yeast hydrolysate according to Example 1 combined with proline (50% w/w of the yeast hydrolysate as prepared in Example 1 and 50% of proline w/w). Each treatment (i.e. T1 and T2) was sprayed on the crowns of ten vines at a dose of 3.33 g L−1 three times every two weeks, namely on June 19, July 3 and July 17, while the other half of the pots was treated only with water (control, C). All pots were maintained under well-watered (WW) conditions, i.e. at 100% of the maximum water capacity of the pots. On July 20, after several days with air temperatures higher than 34-35° C., half of the vines for each treatment, i.e. 5 control, five treated with the yeast hydrolysate and five treated with the yeast hydrolysate in combination with proline, were subjected to a water-stress (WS) of 40% of maximum water capacity. On August 8, all water-stressed vines were re-watered, restoring 100% of maximum water availability until the end of the season. During the water stress period, the affected pots were covered with a plastic film to avoid interference from rainfall and contain evaporation losses.

### Evaluation of the Physiological Responses to Abiotic Stress

Photosynthetic activity (P), transpiration rate (E), and stomatal conductance (gₛ) were measured periodically from late June to early September during the hottest hours (between 12:00 and 13:00) using a portable open system, namely an LCA-3 infrared gas analyzer (ADC Bio Scientific Ltd, Herts, UK). Water use efficiency (WUE) was calculated as the Pₙ/gₛ ratio. Ten leaves (five vines per treatment, two leaves per vine) fully exposed to the sun were measured for each treatment. On the same leaves and on the same days, total chlorophyll content was estimated with a nondestructive instrument (SPAD-502 chlorophyll meter—Konica Minolta Ltd., Hungary) and chlorophyll fluorescence with a portable continuous excitation fluorometer (Handy-PEA, Hansatech Institute Ltd, Norfolk, UK). The instrument measures the Fᵥ/Fₘ ratio and the “Area” parameter. Fᵥ/Fₘ is the photochemical efficiency of PSII photosystems present on the reducing sites of leaf chloroplasts (in practice, it highlights any photoinhibition taking place when its value is below 0.6), where Fₘ is the maximum fluorescence, Fᵥ is the difference between Fₘ and Fₒ(basic fluorescence). The parameter “Area” is the size of the pool of plastoquinones present on the reducing sites of PSII. (Strasser et al., 1995).

### Water Potential

Plant water potential was measured on August 1 and 6, when the vines were in water-stress conditions (WS), and on August 9 at re-watering using a pressure chamber (model 1000, PMS Instruments Co., USA). For each date, measurements were made on ten leaves per treatment (five vines per treatments, two leaves per vine) during the hottest hours of the day (between 12:00 and 13:00) after wrapping the leaves in aluminium foil for 20 minutes.

### Grape Yield and Composition

At harvest in September, the following were determined: yield per plant, average bunch and berry weight, sugar content (° Brix), titratable acidity, and pH on three replicates of grape samples for each treatment consisting of 150 randomly sampled berries. Sugar content (° Brix) was determined with a refractometer (RX-500 Atago-Co Ltd, Tokyo, Japan). Titratable acidity was measured with a Tritex Universal Potentiometric Titrator (Steroglass S.r.l., Perugia, Italy), titrating with a 0.1 N NaOH solution to the point of color change identified with bromothymol blue; results were expressed as g L⁻¹ of equivalent tartaric acid. The pH of the must was measured using a standard PHM82 pH meter (Radiometer, Copenhagen, Denmark). Anthocyanin and polyphenol contents (expressed as mg cm⁻² of skin) were determined on the epidermis of berries according to the method of Ough and Amerine (1988) and Slinkard and Singleton (1977).

### Statistical Analysis

The experimental data were statistically analyzed by ANOVA using DSAASTAT software.

### Results

### Temperatures and Precipitations During the Study

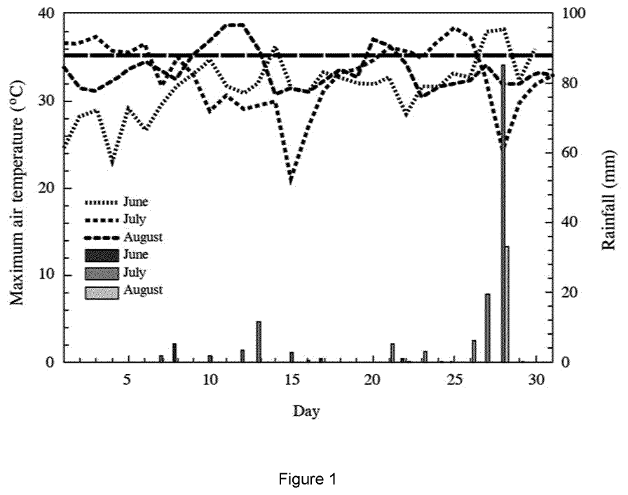

As shown in FIG. 1, during the period of experiments, as many as 22 days with maximum air temperature (T° max) above 35° C., precisely four days in June, 11 days in July, and seven days in August were observed. June was very hot and dry, with peaks of T° max of 38.1° C. and only 1.8 mm of rainfall. July and August also saw peaks of T° max of 38.4° C. and 38.7° C., with substantial rainfall concentrated in very few days. In fact, on 28 July there was 83 mm of precipitation, followed by a drop in the maximum air temperature of 10° C.

### Physiological Response to Abiotic Stress

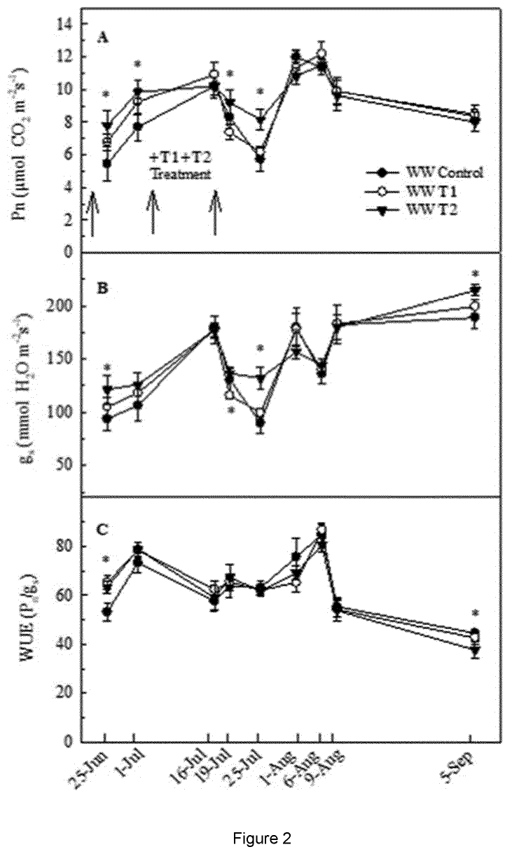

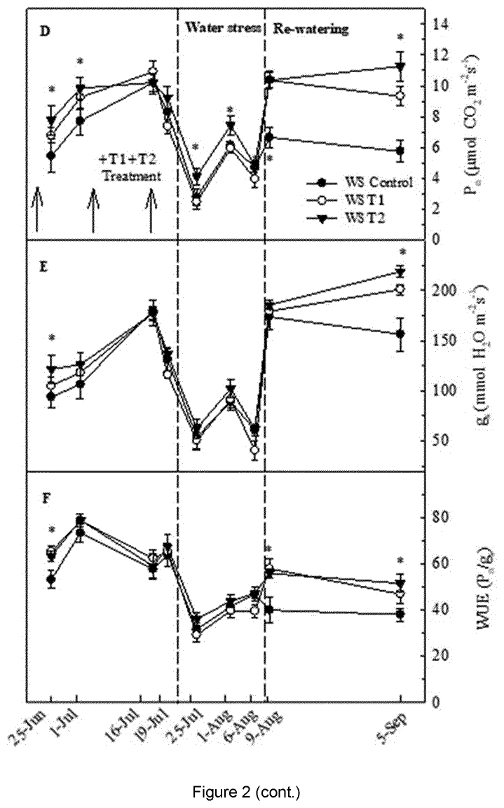

Under well-watered (WW) condition, just after one week after the treatments T1 or T2, a significant increase of total chlorophyll content, Pₙ and gₛ were found, especially on days with air temperature above 32° C. (FIG. 2).

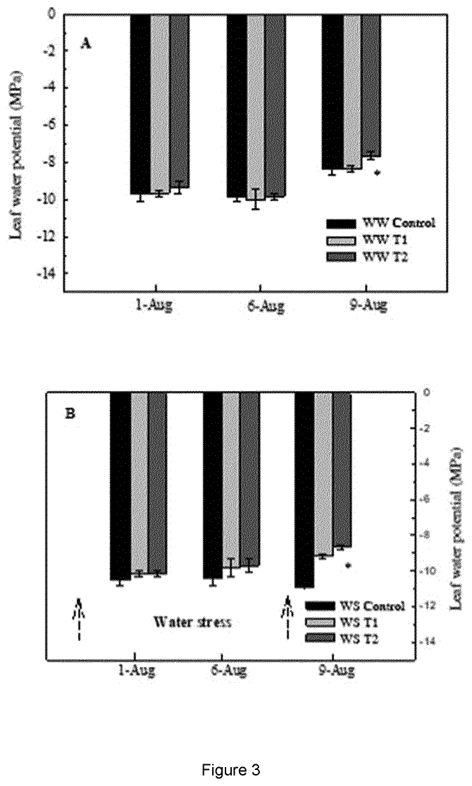

Under water-stress (WS) conditions, only T2-treated vines had enhanced Pₙ compared with the control, by +48% on July 25 (5 days after the onset of water stress) and +21% on August 1 (12 days after the onset of water stress), respectively (FIG. 2D). Upon re-watering, plants treated with both T1 and T2 responded promptly with a fast and consistent recovery of Pₙ (+56%), gₛ (+40%) and WUE (+40%), in contrast to control plants (FIGS. 2D, E and 2F). Treated vines, in addition to rapidly recovering photosynthetic efficiency after the stress period, maintained leaf apparatus in activity longer, presenting consistently higher Pₙ even in September (FIG. 2D). This higher canopy efficiency was also evidenced by higher WUE values (FIG. 2F). In fact, at re-watering the T1 and T2 treated vines had a higher or less negative water potential than the control (FIG. 3B).

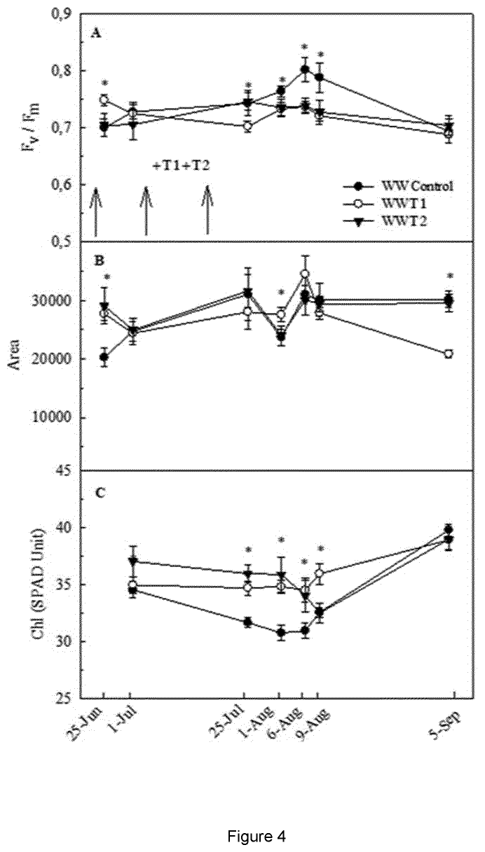

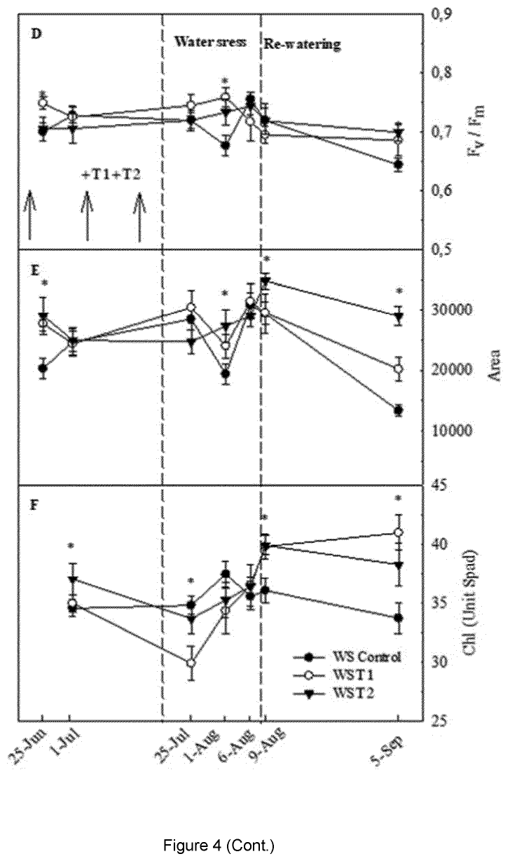

During the WS phase (August 1), plants treated with both treatments maintained a higher photochemical efficiency of PSII than the control, as evidenced by Fᵥ/Fₘ values above 0.65 (FIG. 4D). While in control vines, Fᵥ/Fₘ values fell close to the threshold value of 0.65, which triggers chronic photoinhibition processes with chlorosis and necrosis in leaf tissues (FIG. 4D). The higher photochemical efficiency of PSII of treated plants was maintained at optimal values even during September, probably also due to higher chlorophyll content in leaves (FIG. 4F).

In summary, under stress, T1 and T2 improved Pₙ, gₛ, photochemical efficiency of PSII (Fᵥ/Fₘ) and the plastoquinone pool size during the entire period of stress. After re-watering, the leaves of T1 and T2 treated vines showed a Pₙ, gₛ, plastoquinone pool size, Fᵥ/Fₘ and total chlorophyll content higher than the control vines. Moreover, both in well-watered (WW) and water-stress (WS) conditions, especially at midday when the air temperature was above 35° C., the T1 and T2 treatment helped to preserve the stem water potential compared to the control vines.

### Grape Yield and Composition

Compared to control vines, T1 and T2 treated vines exhibited higher grape production both under well-watered (WW) (about +18%) and water-stress (WS) (+16%) conditions (Table 1). This increase in production per vine can be attributed to a significantly higher average berry weight compared to the control under both WW (on average +16%) and WS conditions (on average +15%).

TABLE 1
Average cluster number, cluster and berry weight, number of
berries per cluster, and yield at harvest in seven-year-old
Sangiovese vines treated with T1 and T2 under WW and WS conditions.
Data show the mean. Different letters indicate significant
statistical differences between treatments (P < 0.05).

| | Bunches/ | Weight | Weight | Grapes/ | |
|---|---|---|---|---|---|
| | vine | cluster | grape | cluster | Yield |
| | (no) | (g) | (g) | (no) | (kg/vine) |
| WW-Control | 8 | 210 b | 1.29 b | 161 a | 1.68 b |
| WW-T1 | 8 | 242 a | 1.44 b | 168 a | 1.94 a |
| WW-T2 | 8 | 256 a | 1.55 a | 165 a | 2.05 a |
| WS-Control | 7 | 205 b | 1.14 c | 178 a | 1.40 a |
| WS-T1 | 7 | 233 ab | 1.33 b | 175 a | 1.61 b |
| WS-T2 | 7 | 236 ab | 1.36 b | 174 a | 1.65 b |

Under water-stress (WS) conditions, grapes from Sangiovese vines treated with both T1 and T2 accumulated greater amounts of sugars and total polyphenols, compared to the control (Table 2). Both treatments preserved greater amounts of organic acids in the must under both WW and WS conditions.

TABLE 2
Average sugar content, titratable acidity, must pH and total
polyphenols concentration in the skins of 7-year-old Sangiovese
vines treated with T1 and T2 under WW and WS conditions. Data
show the mean. Different letters indicate significant statistical
differences between treatments (P < 0.05).

| | Sugar | Acidity | | Polyphenol |
|---|---|---|---|---|
| | content | titrability | | totals |
| | (°Brix) | (g/l) | Must pH | (mg cm⁻²) |
| WW-Control | 21.40 b | 5.80 c | 3.33 a | 0.93 b |
| WW-T1 | 21.93 b | 6.60 ab | 3.26 a | 0.87 c |
| WW-T2 | 21.77 b | 7.12 a | 3.21 a | 0.96 b |
| WS-Control | 21.45 b | 6.40 b | 3.20 a | 0.84 c |
| WS-T1 | 23.00 a | 6.38 b | 3.30 a | 1.07 a |
| WS-T2 | 24.07 a | 6.70 ab | 3.38 a | 1.09 a |

In conclusion, it was found that T1 and T2 enhanced net photosynthesis of leaves under conditions of water and thermal stress. Upon re-watering, both treatments resulted in a fast and consistent recovery of photosynthesis, water use efficiency (which means that the same amount of H₂O used in the organic transpiration process results in more moles of CO₂) as well as stem water potential. T1 and T2 are able to maintain fully functional leaves for longer periods of time once summer stresses are overcome, as evidenced by the values of Pₙ, Fᵥ/Fₘ, plastoquinone pool size and total chlorophyll content. Both tested treatments enhanced grape production under both water-stress (WS) and well-watered (WW) conditions with T° max above 35° C. for 7 consecutive days. Regarding the composition of grapes at harvest, both treatments T1 and T2, under multiple summer stress conditions, increased the sugar and total polyphenol content in the skins.

In other words, the treatments T1 and T2 exerted positive effects against water deprivation and high air temperature through maintenance of basic physiological processes and limiting photoinhibition phenomena. Moreover, the treatment improved yield and grape composition and help the recovery of physiological functions after restoring the normal environmental conditions.

The hydrolyzed yeast of the present disclosure (i.e. T1) combined or not with proline (i.e. T2) represents a technical aid, especially in vintages and/or in wine-growing areas that are particularly photo-inhibiting, in better tolerating the negative effects exerted by water shortage and thermal and luminous excesses.

### Example 3: Foliar Application of a Yeast Hydrolysate in Order to Improve Vineyard Resilience to Multiple Summer Stress

Water shortage, high air temperatures and radiative excess are limiting factors increasing by frequency and intensity in most of the wine regions worldwide. The objective of this trial was to evaluate whether the yeast hydrolysate of the present invention (in combination or not with proline) could improve vineyard resilience to multiple summer stress and increase grapevine physiological and productive performances under water deficit.

### Materials and Methods

The trial was conducted in a vineyard on cultivar Barbera located in Bacedasco Basso (Vernasca, PC, 44° 50′09″N 9°54′59″E). Due to the geo-pedological and climatic constraints, row orientation and varietal sensitivity, the vineyard is frequently subjected to warm spells and periods of severe drought. A plot of 96 vines was divided in four complete randomized blocks (RCBD) encompassing four treatments: Control; T1 (yeast hydrolysate of the present disclosure as prepared in Example 1); T2 (75% w/w of the yeast hydrolysate as prepared in Example 1 and 25% w/w of proline) and T3 (50% w/w of the yeast hydrolysate as prepared in Example 1 and 50% of proline w/w) (six vines per treatment per block). Yeast hydrolysates have been foliarly applied as follows:
T1: first application at pre-bloom followed by five applications between groat-size phenological stage and full veraison, at the dosage of 1.7 g/L; and
T2 and T3: five applications between groat-size phenological stage and full veraison, at the dosage of 3.33 g/L;
Detail of the treatment application is as followed: 28 May; 15 June; 26 June; 10 July; 21 July and 7 August.
Control: Untreated vines.

Leaf gas exchange parameters, PSII efficiency and stem water potential were analyzed in five different days on 12 vines per treatments, on a mature well exposed primary leaf per vine. Measures were taken at 14:00 on the south exposed canopy side.

On DOY 202 and 209, thermal image of one leaf, one bunch and of the entire canopy were acquired with a FLIR i60 infra-red thermal imaging camera (FLIR Systems Inc., Wilsonville, OR, USA). Thermal images were elaborated with Flir Tools software (FLIR Systems Inc., Wilsonville, OR, USA) and leaf, canopy and bunch minimum temperature (Tmin), maximum temperature (Tmax) and mean temperature (Tmean) were then calculated.

On three specific dates, four groups of primary mature leaves per treatment have been sampled, immediately frozen and then stored at −20° C. Leaf proline concentration was then determined as described in Carillo and Gibon (2011).

To separate leaf proline concentration and proline deposit on leaf surface, a separate trial was executed in September, spraying with T3 at 3.33 g/L two potted Pinot noir vines. Leaf proline concentration was determined one hour before the treatment and one, 72, 144, 244 and 360 hours after the treatment application.

In the field-trial, during ripening course, sunburn incidence and severity was visually assessed on a weekly basis. Sunburn incidence was recorded for each experimental vine as the number of bunches showing symptoms on the total. Sunburn severity was instead recorded as the average percent of berries affected by sunburn on symptomatic bunches.

McKinney index was then calculated as (incidence*severity)/(max incidence*max severity).

At harvest, vine yield was measured and the number of bunches per vine was recorded. Bunch weight was then calculated. A sample of three bunches was sampled on each experimental vine (12 vines per treatment). The samples were brought in the laboratory, where bunch compactness and berry mass were measured. Then, berries were crushed and must total soluble solids, pH and titratable acidity were quantified. Fifty berries per vine were stored for the determination of total anthocyanins and phenolics following the method described in land et al. (2004).

### Results

### Vine Water Status and Physiological Performances

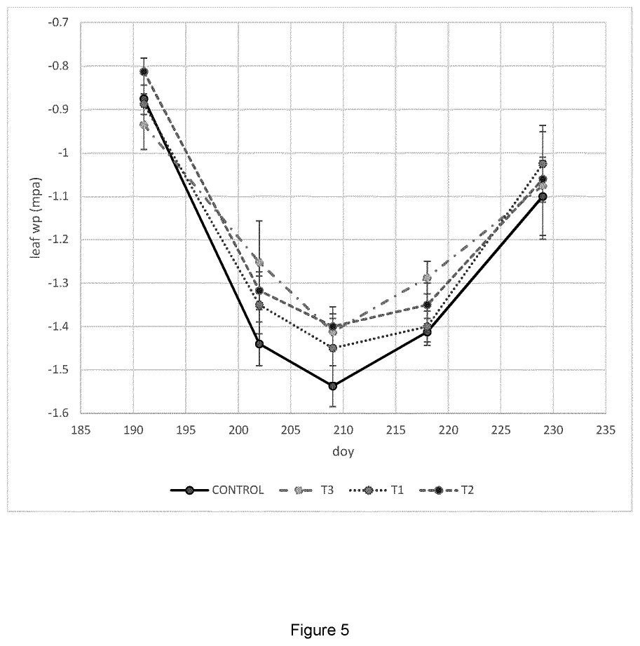

During the experiment, control vines showed a decline of leaf water potential (ψ) passing from −0.88 MPa on DOY (day of year) 191 to −1.55 MPa on DOY 209 (FIG. 5). After 29 mm of rain fallen on DOY 216, control vines resumed a slightly higher ψ, that, however, remained below −1.4 MPa. On DOY 229, when also air temperatures ranged to lower values, ψ of control vines was restored to −1.1 MPa. In vines treated with T1, ψ was always higher than control vines throughout the entire season. All treatments improved vine life water status when environmental conditions were particularly limiting.

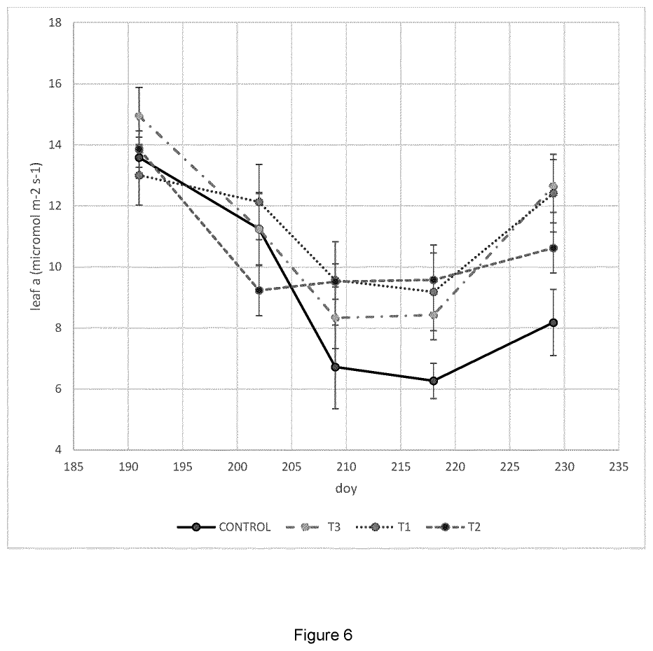

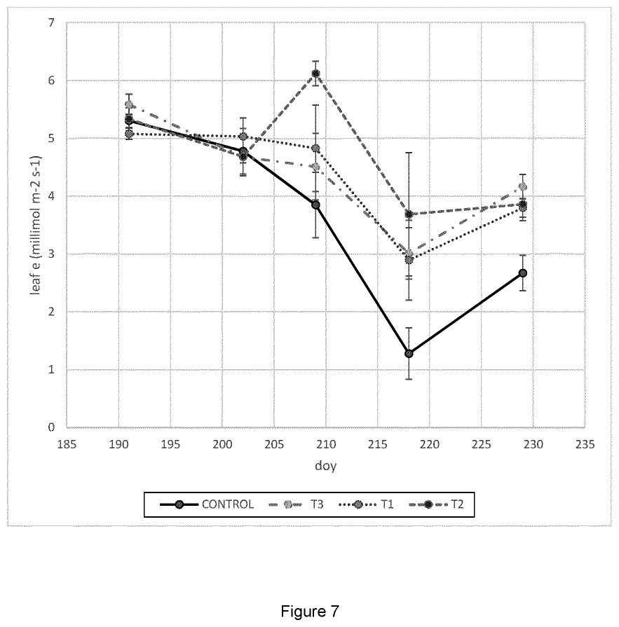

As shown in FIGS. 6 and 7, on DOYs 191 and 209, no differences among treatments were found for leaf photosynthetic (FIG. 6) or transpiration rates (FIG. 7). On the contrary, on DOY 218, all treatments T1 to T3 improved leaf photosynthesis and transpiration. More particularly, when control vines exhibited a decline of leaf photosynthesis to 6 μmol m⁻² s⁻¹, all treatments set at about 9 μmol m⁻² s⁻¹. Similarly, on DOY 229, when non-limiting conditions were restored, control vines did not resume leaf assimilation rates as compared to T1 to T3 (−4 μmol m⁻² s⁻¹). Quite similar trends were observed on transpiration rates, i.e. transpiration rates on DOY 218 were reduced to 1.2 mmol m⁻² s⁻¹ on Control vines, whereas on all T1 to T3 treatments the transpiration rates were set at 3.5 mmol m⁻² s⁻¹. This result was confirmed also on DOY 229. Taken altogether, data suggests that T1 to T3 improved leaf physiological performances especially when high air temperatures were limiting ordinary vine physiological functioning. The consistently better physiological functioning of treated vines on DOY 229 suggests that the treatments T1 to T3 can be particularly efficient at re-watering or when non-limiting conditions are restored.

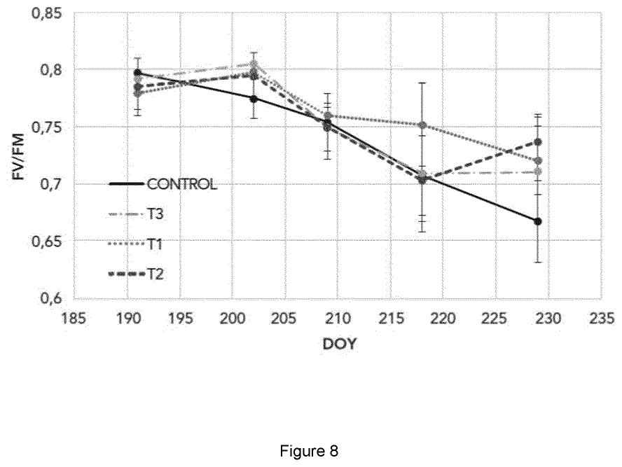

As shown in FIG. 8, the PSII maximum quantum yield (Fᵥ/Fₘ) declined steadily in control vines and on DOY 229 set at about 0.66, meaning the onset of non-reversible photoinhibitions and leaf yellowing. On DOY 229, T1 to T3 had a significantly higher PSII maximum quantum yield than control vines. This means that the tested treatment prevented the leaves from losing the capability of resuming full photosynthetic rates, in case non-limiting conditions are restored in the subsequent part of the season.

### Leaf, Canopy and Bunch Thermal Status

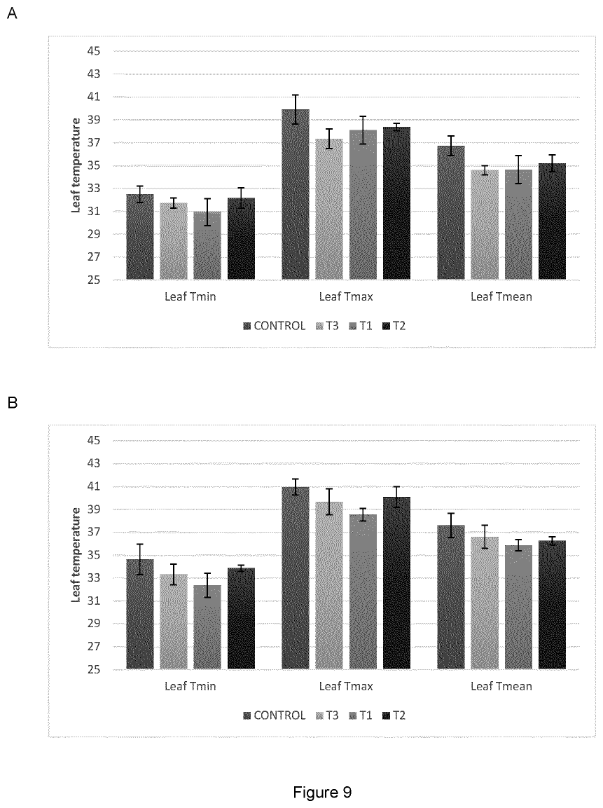

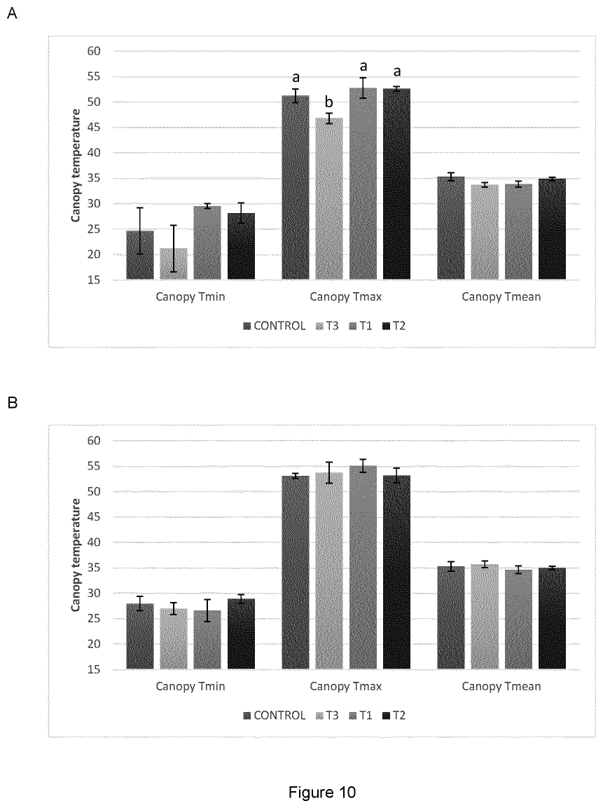

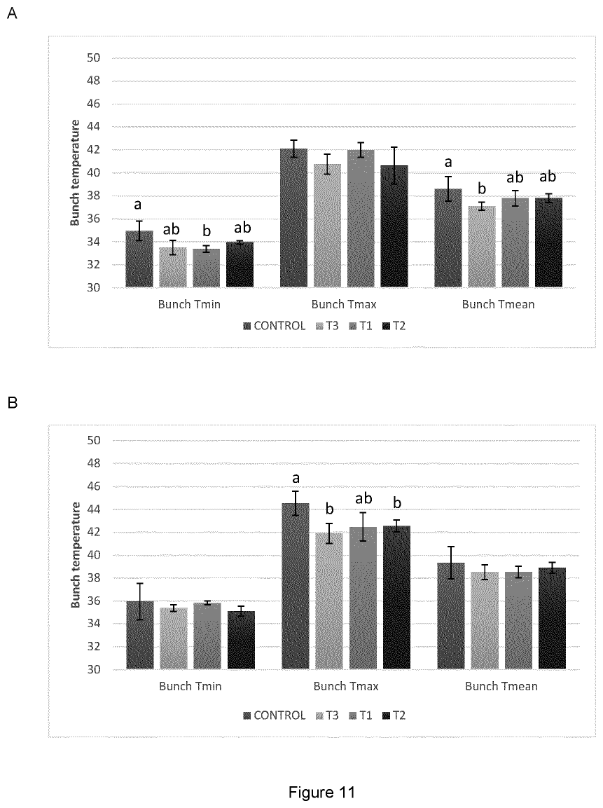

As shown in FIGS. 9 to 11, all tested treatments T1 to T3 were effective in preventing the overheating of sun-exposed main leaf.

### Leaf Carbohydrates and Proline Concentration

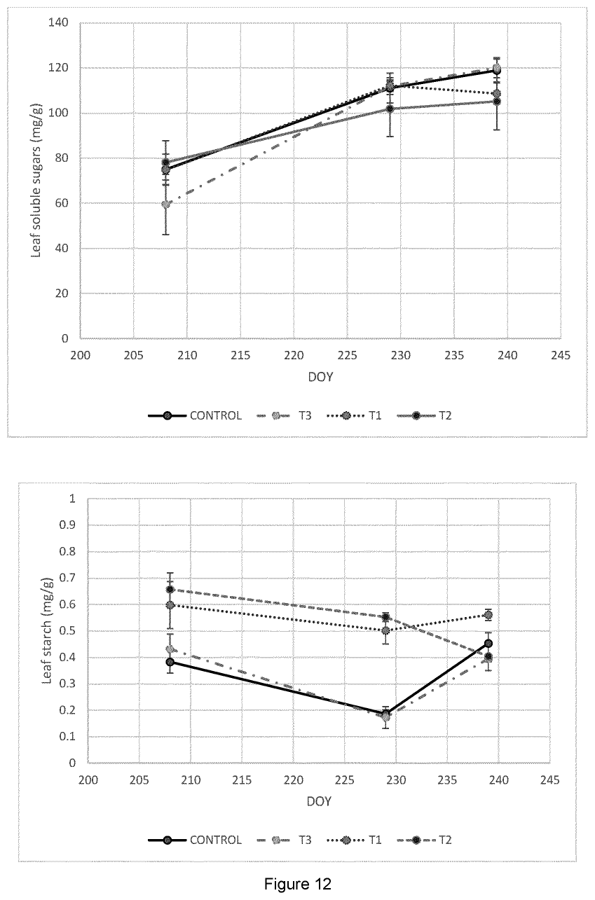

The treatments T1 to T3 did not affect leaf soluble sugars in any of the sampling dates (FIG. 12). Conversely, leaf starch was notably and consistently increased by T1 (+56% on DOY 208, +170% on DOY 229 and +24% on DOY 239, as compared to control). Higher starch concentration as observed in T1 could be linked to the higher leaf photosynthetic rates and which contribute to ameliorate vine carbon balance when assimilation rates are limited by environmental factors.

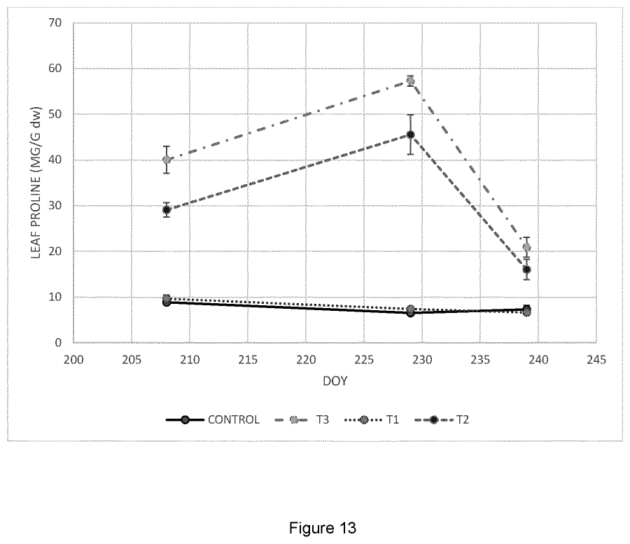

Leaf proline concentration was measured first on DOY 209, in absence of a severe water-stress, after four to five T1 to T3 treatment applications (FIG. 13). On DOY 209, T2 and T3 showed a dramatic increase in leaf proline concentration, by 200% and 300% respectively, as compared to control vines and T1 which does not contain proline. This was confirmed also by the analysis on leaves sampled on DOY 229 after an additional yeast hydrolysate application, when the magnitude of leaf proline increase was even higher (T2+360% and T3+480%, as compared to controls). Finally, after other ten days (leaves sampled on DOY 239), in absence of additional yeast hydrolysate applications, the proline concentration in T2 and T3 was still higher than control vines, but the differences were lower (+180% in T2 and +150% in T3).

### Prevention of Grapes Sunburn Spread

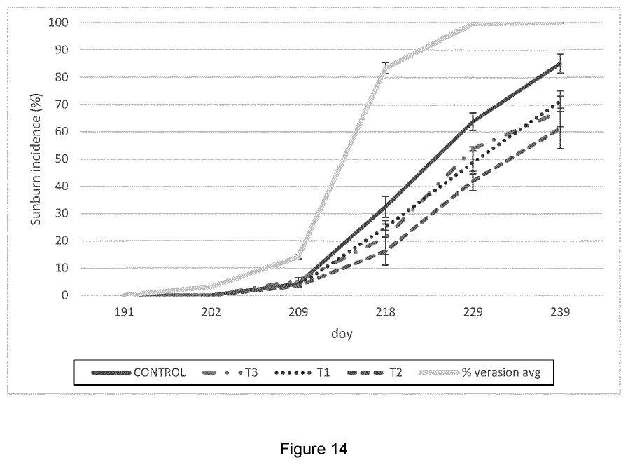

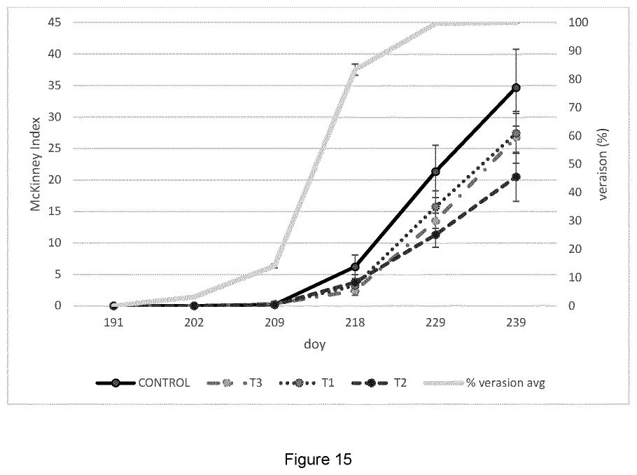

Treatments T1, T2 and T3 reduced the evolution of the sunburn incidence during ripening progression. More particularly, the three treatments showed a lower sunburn incidence starting from DOY 218, then confirming the trend in the subsequent assessments up to harvest (FIG. 14). The McKinney index (FIG. 15), integrating sunburn incidence and severity, shows that all three treatments showed capacity in reducing sunburn at harvest (14% of the total berries, versus 54% in control vines, Table 3). Moreover, data indicates that the tested treatments can be effective in postponing sunburn spread.

### Vine Productivity and Bunch Morphology

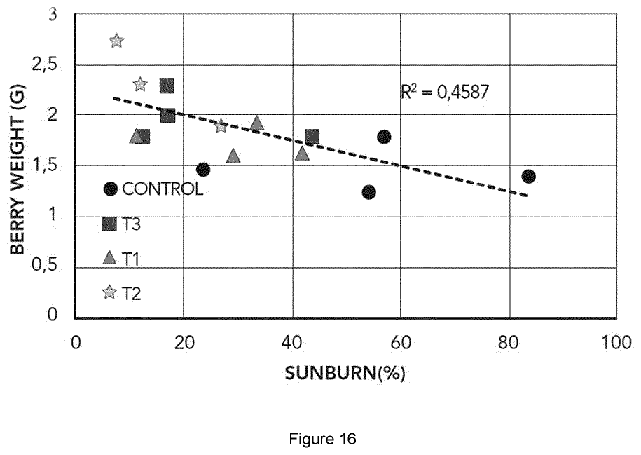

As shown in Table 3, T1 significantly increased yield, as compared to control vines (+38%) closely followed by T2 and T3. The yield increase was essentially reflected by the average bunch weight, that, in turn, was linked to berry weight, significantly higher in all the treatments, as compared to control (+0.65 g as an average of the three treatments). Berry weight was inversely correlated to sunburn spread (y=−0.01x+2.25, R2=0.46), meaning that berry weight was not increased by the application of the treatments T1, T2 and T3, but, on the contrary, treated bunches did not undergo dehydration process like control grapes, which loose a significant fraction of their weight (FIG. 16). Bunch compactness was lower in control vines as a function of the higher proportion of dehydrated berries.

TABLE 3
Vine yield and bunch morphology according to treatments T1 to T3

| | | | Bunch | | Bunch | Berry |
|---|---|---|---|---|---|---|
| | Yield | Bunches/vine | weight | Sunburn | compactness | weight |
| Treatment | (kg/vine) | (no) | (g) | (%) | (g/cm) | (g) |
| Control | 2.15 b¹ | 18 | 124.08 b | 54 a | 10.98 a | 1.48 b |
| T1 | 3.45 a | 21 | 167.40 a | 29 b | 11.58 bc | 1.94 a |
| T2 | 2.76 ab | 19 | 142.48 ab | 14 c | 15.68 a | 2.32 a |
| T3 | 2.52 ab | 19 | 135.67 ab | 22 bc | 12.51 b | 1.98 a |

¹Different letters indicate significant differences per P < 0.05 (SNK test)

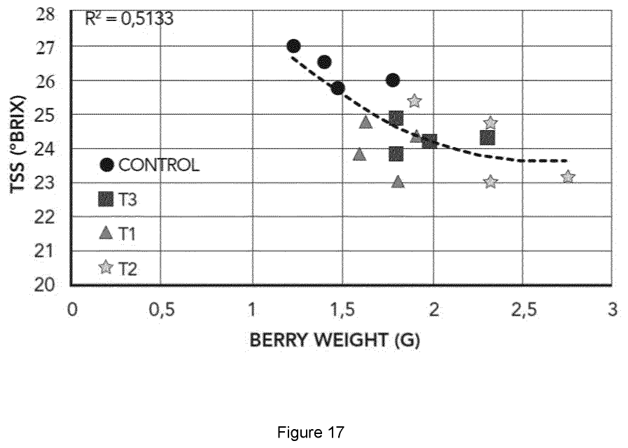

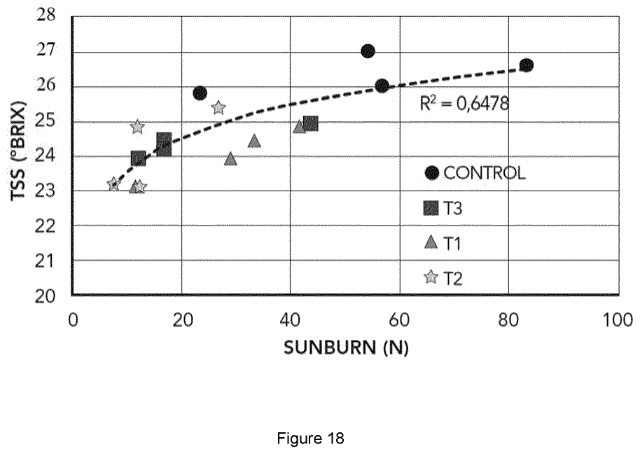

As a result, grapes from control vines reported a dramatically high soluble sugars concentration at harvest, whereas all treatments maintained total soluble solids (sugar, TSS) concentration between 24.1 and 24.4° Brix (Table 4). More than 50% of TSS variability was explained by the berry weight (y=1.64×2−8.51x+34.69, R2=0.51) and, consequently, by sunburn spread (y=0.01×2+0.07x+22.30, R2=0.65). This means that the higher sugar concentration in control grapes was mainly linked to sunburn and to dehydration process leading to metabolites concentration (FIGS. 17 and 18). This is also confirmed by the higher titratable acidity of control grapes, which was mainly due to the higher concentration of tartaric acid that, in turn, was caused by berry water loss.

TABLE 4
Fruit composition, grapes phenolics and organic acids
concentration according to treatments T1 to T3

| | | | Titratable | | Total | Tartaric | Malic |
|---|---|---|---|---|---|---|---|
| | TSS | | acidity | Anthocyanins | phenolics | acid | acid |
| Treatment | (°Brix) | pH | (g/L) | (mg/berry) | (mg/berry) | (g/L) | (g/L) |
| Control | 26.4 a¹ | 3.30 | 7.93 a | 3.311 a | 6.417 a | 8.626 a | 3.336 |
| T1 | 24.1 b | 3.27 | 7.77 ab | 3.257 a | 5.349 b | 7.492 b | 3.109 |
| T2 | 24.1 b | 3.22 | 7.59 ab | 2.508 b | 6.987 a | 7.660 b | 3.477 |
| T3 | 24.4 b | 3.31 | 7.49 b | 3.514 a | 6.967 a | 7.397 b | 3.453 |

¹Different letters within columns indicate significant differences per P < 0.05 (SNK test)

Overall, T1, T2 and T3 changed grapes biochemical composition and preserved a more balanced fruit composition when control vines exhibited excessive sugars and metabolites concentration (Table 5). All these effects seem related to the reduction of sunburn and berry dehydration.

TABLE 5
Grapes biochemical composition according
to different T1 to T3 treatments

| Treatment | TSS/TA | TSS/anthocyanins | TSS/phenolics | HT/HM |
|---|---|---|---|---|
| Control | 3.32 a¹ | 14.15 b | 7.27 a | 2.68 a |
| T1 | 3.14 b | 16.53 a | 7.73 a | 2.47 ab |
| T2 | 3.11 b | 16.69 ab | 8.21 a | 2.22 b |
| T3 | 3.28 ab | 14.54 b | 6.84 b | 2.22 b |

¹Different letters within columns indicate significant differences per P < 0.05 (SNK test)

In conclusion, T1 to T3 preserved leaf water status, especially when environmental conditions became more limiting. Indeed, T1 to T3 preserved stomatal conductance and photosynthetic rates under severe water stress and later in the season when non-limiting conditions occurred again.

In a vineyard severely affected by sunburn and berry dehydration, all tested treatments postponed the onset of sunburn, so reducing the rate of dehydrated berries at harvest and increasing yield per vine. This preserved grapes biochemical composition and avoided the loss of the proper balance between primary and secondary metabolites. Results do show that T1 postpone Barbera grapes ripening.

### Example 4: Evaluation of Yield Recovery after Hail Damage

The objective of this study was to evaluate the yield recovery after hail damage.

### Materials and Methods

The experimental design was carried out in randomized blocks, with a total of 2 experimental treatments: a control treatment (CT) and a yeast hydrolysate as prepared in Example 1. Each elementary plot consisted of 48 vines, of which 24 were control.

The yeast hydrolysate treatment was applied on three different dates of the vegetative cycle. The first application was made on May 31, coinciding with phenological stage g (separated clusters) and just after the hail damage occurred at a dose of 3 g/L with a total volume applied of 16 L per treatment. The second application was made two weeks later, on June 14, also by knapsack sprayer at a dose of 3 g/L for each product and with a total applied volume of 18 L per treatment. The third and final application was made two weeks later, on June 28, using an overhead sprayer, at a rate of 3 g/L for each product, with a total applied volume of 43 L per treatment.

The estimation of grape production was carried out through manual harvesting in each control vine of each experimental plot and its subsequent weighing by means of portable industrial scale A & D CO., LTD, with a resolution of 5 g. At the same time, the total number of bunches per vine was counted individually. The berry weight was determined by sampling in each repetition, for which a Kern & Sohn Gmbh table scale with a resolution of 0.01 g was used. The production components determined were: yield (kg/strain), number of bunches per vine, bunch weight (g), berry weight (g), number of berries per bunch and fertility (no. bunches/bunch).

### Results

The campaign was characterized climatologically by presenting a level of precipitation above the annual average for the area, with a good distribution of precipitation throughout the cycle. Although throughout the previous autumn months the soil did not accumulate much water, this trend changed in the winter and spring months, in which precipitation increased notably. A similar amount of water was collected in both periods, 248 mm, which translated into a total effective precipitation of 242 mm in both seasons. Throughout the summer, precipitation was scarce, below average, especially in the month of August when there was no precipitation. During the early autumn, until the trial harvest, rainfall was normal for this time of year.

Temperature values were also within the average for a typical year for the area, with perhaps somewhat higher temperatures during the first half of April, which favored a somewhat earlier budbreak. The most notable frost occurred on May 13, with a temperature at dawn of −1.37° C., which clearly affected the part of the vineyard where the experimental hail and frost trial was carried out. As for the rest of the months, temperatures were within normal values, with only the maximum and average temperatures in July and August being somewhat higher (1° C.) than usual.

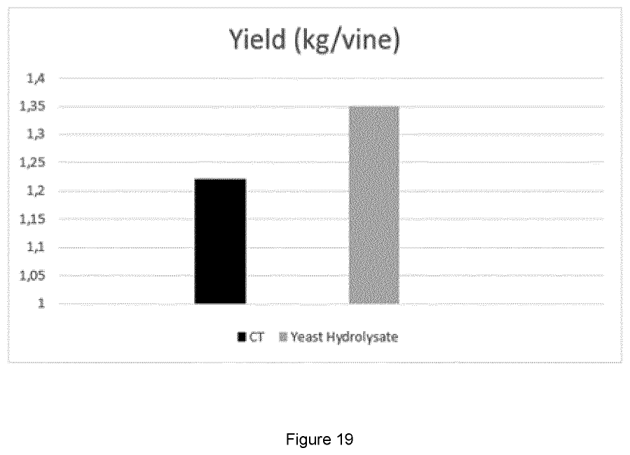

The yield of the yeast hydrolysate treatment was 11% higher than the control (FIG. 19). Further, the yeast hydrolysate had a positive effect on the bunch weight, berry weight and number of berries per bunch.

### Example 5: Effects of Foliar Application of Yeast Hydrolysate on Water Stress Tolerance of Arabidopsis thaliana Plants

This experiment was conducted on four weeks old Arabidopsis thaliana plants. The objective was to track the dynamics of rosette expansion over time by means of an automated phenotypic characterization approach by using the Phenotiki system (http://phenotiki.com/) installed in a growth chamber. This was accomplished by acquisition of three images per day over the entire experimental period. The Phenotiki program allows real time monitoring of rosette (leaf area) expansion, however only of plants with relatively small size. This is needed specially to avoid overlapping of leaves for accurate leaf area measurements. Medium-sized (4 weeks old, 10 leaves) plants were used at the beginning of the experiment.

The plants at the time of the second treatment all had a field capacity equal to 100%, then after the treatments “Well Watered” (WW) plants were maintained in a range of 60-70% of field capacity while “Water Stress” (WS) plants were brought to and kept within a 15-30% range of field capacity. Water loss was monitored daily by weighing each individual pot and the daily water loss was given back to each pot to reach the desired water field capacity. The plants went into stress (field capacity equal to or less than 30%) after about four days from the second treatment. For each experimental treatment, 5 plants (biological replicates) were used. The experiment was repeated twice. All treatments were applied at a concentration of 3.3 grams per L by maintaining the powder in suspension with regular shaking and spraying on the entire leaf surface. The following treatments have been tested: Control; T1 (yeast hydrolysate of the present disclosure as prepared in Example 1); T2 (75% w/w of the yeast hydrolysate as prepared in Example 1 and 25% w/w of proline), T3 (50% w/w of the yeast hydrolysate as prepared in Example 1 and 50% of proline w/w), T4 (proline) and T5 (yeast cell walls (Lallemand)).

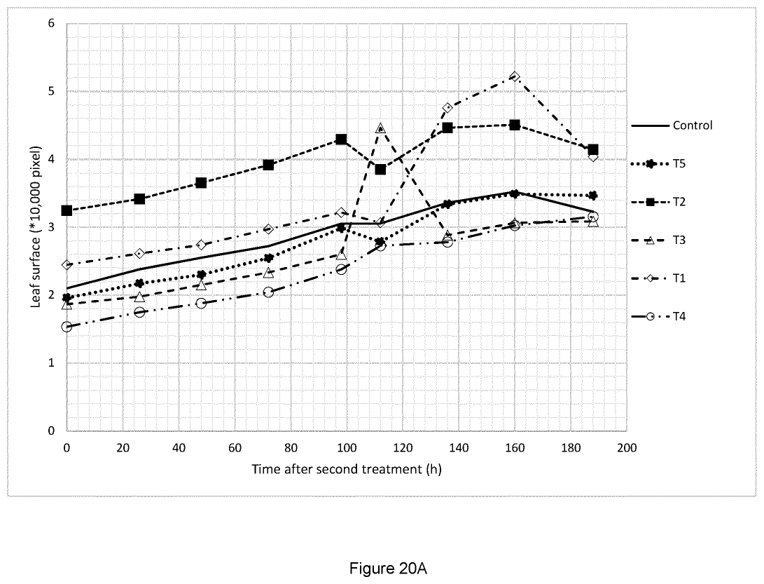

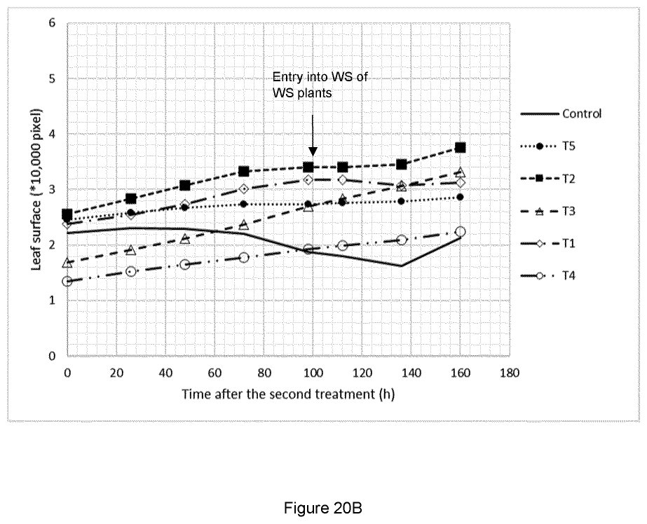

The dynamics of total leaf area development for each experimental treatment is shown in FIG. 20 for well-watered (WW) (FIG. 20 (a)) and water stress (WS) (FIG. 20 (b)) conditions along the entire experimental period.

The results demonstrated that T1, T2, and T3 had an overall positive effect on leaf area development under WS conditions. Under WS it was apparent that the total leaf area of control plants was blocked over time due to WS, while treatments T1, T2, and T3 enabled the plants to maintain a progressive growth. Under WW conditions, the best results were observed for T1 and T2 (see FIG. 20A) whereas under WS conditions the best results were observed for T1, T2 and T3 (FIG. 20B).

### Example 6: Gene Expression in Arabidopsis thaliana Plants

Gene expression analyses were conducted by Real-Time RT-qPCR. Leaves were sampled from 6-week-old plants (three replicates for each treatment as defined in Example 5) one day after the WS plants reached the target field capacity (20-30% of field capacity). Total RNA has been extracted for each experimental treatment (3 replicates for 6 experimental treatments for stressed and control plants, 48 extractions in total). The following treatments have been tested: Control; T1 (yeast hydrolysate of the present disclosure as prepared in Example 1); T2 (75% w/w of the yeast hydrolysate as prepared in Example 1 and 25% w/w of proline), T3 (50% w/w of the yeast hydrolysate as prepared in Example 1 and 50% of proline w/w), T4 (proline) and T5 (yeast cell walls (Lallemand)).

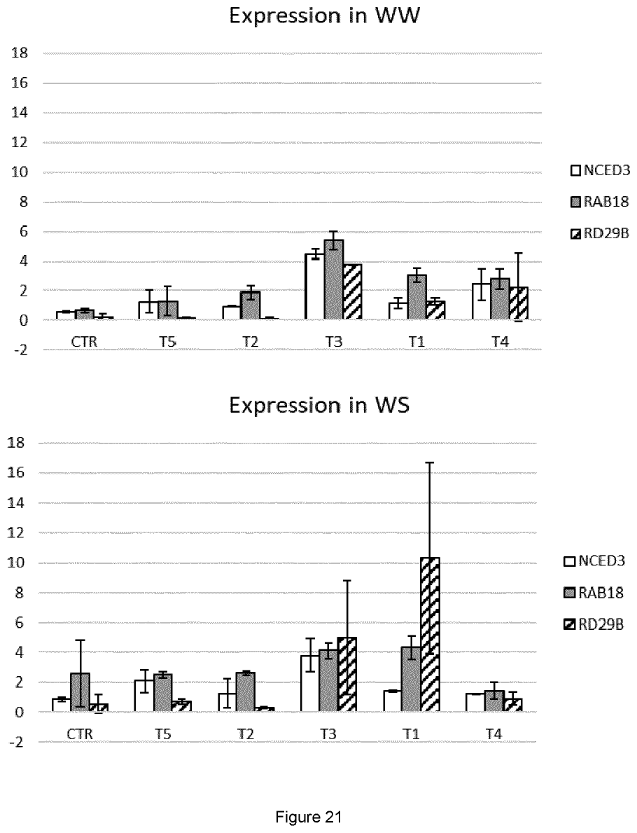

The expression of the ABA biosynthetic marker gene NCED3 and of the ABA-responsive genes RAB18 (Response to ABA 18) and RD29B was used as a proxy for ABA biosynthesis and responses (e.g. leaf stomatal regulation) as a consequence of DYEs treatments in both WW and WS conditions. The results are shown in FIG. 21. It is apparent that T3 resulted in a constitutive induction of NCED3 gene and thus of ABA biosynthesis, and of ABA responses (RAB18 and RD29B induction) already in WW conditions. This induction (compared to control untreated plants) remained similar also in WS conditions.

This induction in T1 treated plants is more evident in WS conditions especially regarding RAB18 and RD29B expression, suggesting an amplification of ABA responses rather than ABA biosynthesis in T1 treated plants since the induction of the biosynthetic gene NCED3 was limited in this experimental condition.

Treatment with T1 resulted in a fine-tuned amplification of abscisic acid (ABA) responses (RAB18 and RD29B) in WS plants. This coincided with a lower stomatal conductance and a higher water use efficiency (WUE) of these plants in WS conditions. This may result in a priming effect rendering the plants more resistant to water stress by preventing an excessive closure of stomata and ensuring an increased WUE under water stress conditions.

### Example 7: Foliar Application of Yeast Hydrolysate to Improve Grapevine Tolerance to an Increasing Water Deficit

The trial was conducted in the outdoor area of Università Cattolica del Sacro Cuore, Piacenza, Italy. Sixteen three-years old vines cv. Pinot Noir were grown in pots filles with a substrate of mixed sand (40%), peat (15%) and loamy local soil (45%), and divided according to the following treatments: 1) untreated control (C); 2) vines sprayed with T1 (75% w/w of the yeast hydrolysate as prepared in Example 1 and 25% w/w of proline) (T). T1 was foliarly applied in the early morning with a hand pump, according to the following timings: DOY 152, DOY 165, DOY 176, DOY 187.

All pots were fully watered until DOY 188. From DOY 189, half of the vines of both treatments were subjected to a progressive water deficit (WS) by reducing the fraction of irrigation from 100% of evapotranspiration (ET) to 0% ET, with intermediate steps (80% ET from DOY 189 to 192, 50% ET from DOY 193 to 194, 0% ET from DOY 194 to 198). Re-watering was applied in the evening of DOY 199 resuming full irrigation on all WS vines. The other half of the vines were kept full-watered (WW) at 100% ET for the entire season. During the experiment were therefore compared the following four treatments: i. well-watered controls (WW-C); well-watered vines treated with T1 (WW-T); iii. water-stressed controls (WS-C); iv. water-stressed vines treated with T1 (WS-T).

Leaf gas exchange parameters, PSII efficiency and leaf pre-dawn and midday water potential were analysed every 2-3 days on four vines per treatments, on a mature well exposed primary leaf per vine. Measures were taken at 12:00 on the south exposed canopy side. After water potential measurement, leaves were sampled, immediately frozen and then stored at −20° C. Samples were used to determine leaf proline concentration after Carillo and Gibon (2011).

Leaf thermal images were taken on DOY 193 with a FLIR IR camera (IR Systems Inc., Wilsonville, OR, USA). Thermal images were elaborated with Flir Tools software (FLIR Systems Inc., Wilsonville, OR, USA) and leaf and bunch minimum temperature (Tmin), maximum temperature (Tmax) and mean temperature (Tmean) were then calculated.

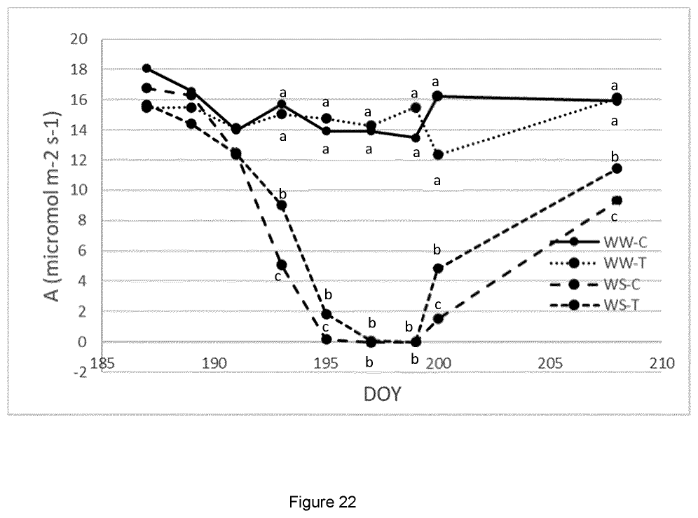

As seen in FIG. 22, in well-watered (WW) vines, leaf photosynthesis (A) ranged between 12 and 18 μmol m⁻² s⁻¹, with no differences due to the treatments. Water-stressed (WS) vines reduced their A starting from DOY 193, but whereas WS-C showed a leaf A of 5.1 μmol m⁻² s⁻¹, WS-T maintained significantly higher A (9.1 μmol m⁻² s⁻¹). On DOY 195, WS-C vines were found having null photosynthesis, whereas WS-T maintained an assimilation rate of 1.9 μmol m⁻² s⁻¹. No difference between WS-C and WS-T was found anymore from DOY 197 to DOY 199, last day of water deficit. On DOY 200, resumption of leaf A was faster in WS-T (5.4 μmol m⁻² s⁻¹) than in WS-C(1.8 μmol m⁻² s⁻¹). This trend remained significant even eight days after rewatering, on DOY 208 when WS-T did not fully recover as compared to WW vines but showed a significantly higher A than WS-C(11.8 μmol m⁻² s⁻¹ vs 9.4 μmol m⁻² s⁻¹).

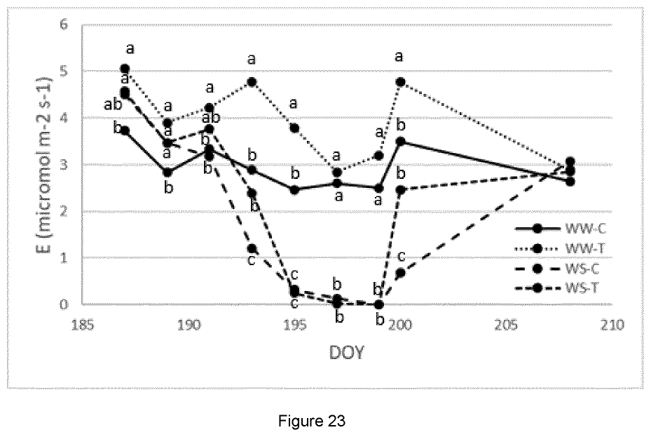

During the experiment, WW-T vines exhibited a consistently higher transpiration (E) than WW-C 4.1 mmol m⁻² s⁻¹ vs 3 mmol m⁻² s⁻¹, as an average of the entire period (FIG. 23). WS-T showed higher leaf E on DOY 193 (+1.2 mmol m⁻² s⁻¹). All WS vines achieved stomatal closure on DOY 195 and resumption of leaf E was faster on WS-T vines, showing +1.75 mmol m⁻² s⁻¹ on DOY 200.

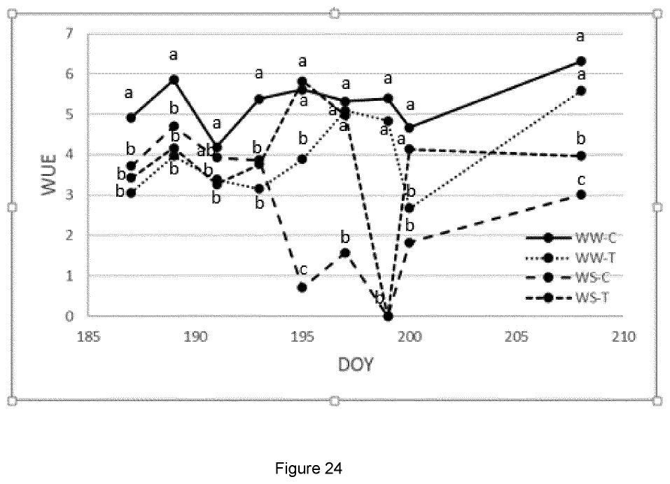

As shown in FIG. 24, WW-C had higher leaf water use efficiency (WUE) during the experiment. Conversely, WS-T vines exhibited a significant increase of leaf WUE from DOY 195, the first day after irrigation full suspension (+1.93 μmol CO₂ m⁻² s⁻¹/mmol H₂O m⁻² s⁻¹ vs WW-C and +5.11 μmol CO₂ m⁻² s⁻¹/mmol H₂O m⁻² s⁻¹ vs WS-C). Differences with WS-C remained significant also on DOY 197, whereas on the last day of water deficit also WS-C WUE dropped close to 0 μmol CO₂ m⁻² s⁻¹/mmol H₂O m⁻² s⁻¹. However, the day when water supply was restored (DOY 200), WS-T exhibited a higher WUE than WS-C (+2.82 μmol CO₂ m⁻² s⁻¹/mmol H₂O m⁻² s⁻¹) and the difference was significant also on DOY 208 (+0.98 μmol CO₂ m⁻² s⁻¹/mmol H₂O m⁻² s⁻¹).

On DOY 193, WS vines had a significantly higher leaf maximum (Tmax), average (Tavg) and minimum (Tmin) temperature than WW by about 4-6° C., 2-6° C. and 2.5-5.5° C., respectively (Table 6). However, if no or minor differences were found between WW treatments, WS-C exhibited significantly higher leaf temperatures than WS-T (Tmax −1.7° C., Tavg—3.2° C. and Tmin −3.1° C.).

TABLE 6
Leaf maximum temperature (Tmax), average temperature (Tavg) and
minimum temperature (Tmin) on DOY 193 in well-watered (WW) and
water-stressed (WS) vines subjected to multiple foliar application
of 75% w/w of the yeast hydrolysate as prepared in Example 1
and 25% w/w of proline, or unsprayed controls (C).

| DOY 193 | Tmax (° C.) | Tavg (° C.) | Tmin (° C.) |
|---|---|---|---|
| WW-C | 35.6 c | 32.8 d | 30.4 c |
| WW-T | 36.6 c | 34.0 c | 30.3 c |
| WS-C | 41.9 a | 39.5 a | 36.1 a |
| WS-T | 40.2 b | 36.3 b | 33.0 b |

² Different letters within columns denote significant difference per P < 0.05 (SNK test)

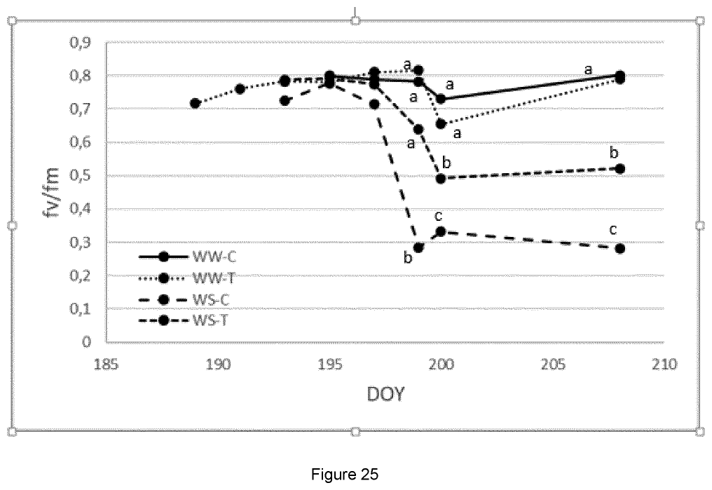

As shown in FIG. 25, Fᵥ/Fₘ value, representing the viability of PSII and the capability of leaves of resuming full photosynthetic functioning if water supply is restored, ranged between 0.7 and 0.8 in WW vines and also in WS vines until DOY 199, last day of stress after four days of full stomatal closure (gₛ=0 mol m⁻² s⁻¹). At this point, WS-C Fᵥ/Fₘ dropped to 0.29, whereas in WS-T Fᵥ/Fₘ was reduced to 0.63, but with no differences with WW vines. However, on DOY 200 and 208 also WS-T showed a Fᵥ/Fₘ significantly lower than WW vines (0.51 vs 0.76), yet still notably higher than WS-C (0.31) vines, that, therefore, exhibited spread onset of photoinhibition (yellowing) on basal leaves.

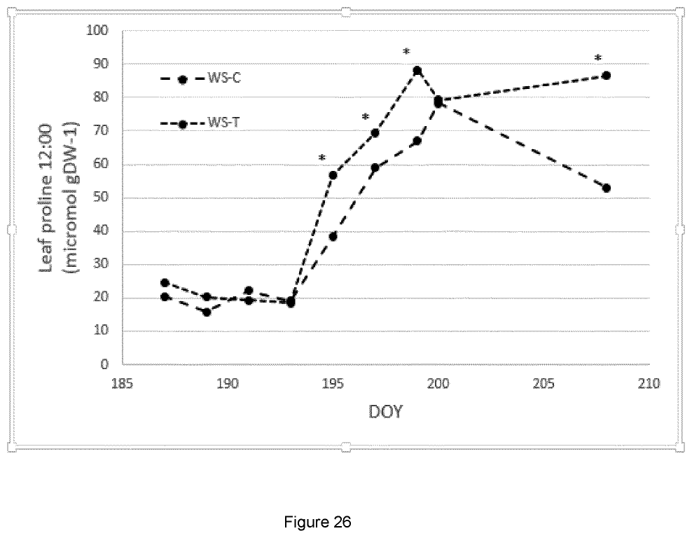

As shown in FIG. 26, WS-T had a consistently higher leaf proline than WS-C(+41%) and on DOY 208 WS-T was still having higher leaf proline concentration.

In conclusion, the treatment was effective in improving vine water status when water deficit ranges across the thresholds identified by Deloire et al. (2020) as moderate to severe water stress. This improvement in water relations helped vines in maintaining better physiological performances under progressive water limiting conditions. When water availability dropped below the wilting point (i.e. stem water potential of about −2 MPa), no differences between treated and untreated vines were found. However, the higher transpiration rates of treated vines under severe stress allow for the preservation of some leaf transpirative cooling that, in turn, helps leaves to avoid the onset of photoinhibition and the loss of the capability in resuming full photosynthetic rates when water comes back available.

Interestingly, as shown in Table 7, WS-T maintained a significantly higher berry mass than WS-C(FIG. 27).

TABLE 7
Fruit composition and bunch morphology at harvest in well-watered
(WW) and water-stressed (WS) vines subjected to multiple foliar
application of 75% w/w of the yeast hydrolysate as prepared in
Example 1 and 25% w/w of proline, or unsprayed controls (C).

| | | Bunch | Berry | Bunch | | | | |
|---|---|---|---|---|---|---|---|---|
| | Yield | weight | mass | compactness | | | Titrable | Malic |
| | (kg/vine) | (g) | (g) | (g/cm) | TSS | pH | acidity | acid |
| WW-C | 2.04 | 146 a² | 1.21 a | 16.49 a | 16.8 c | 3.17 c | 9.34 | 2.10 a |
| WW-T | 1.70 | 117 b | 1.09 ab | 13.84 a | 17.9 c | 3.31 b | 8.18 | 1.70 ab |
| WS-C | 1.63 | 95 c | 0.72 c | 8.24 b | 22.1 a | 3.48 a | 8.93 | 1.44 b |
| WS-T | 1.70 | 105 bc | 0.98 b | 9.82 b | 20.4 b | 3.58 a | 8.01 | 1.36 b |

²Different letters within columns denote significant difference per P < 0.05 (SNK test).

### REFERENCES

Carillo, P., & Gibon, Y. (2011). Protocol: extraction and determination of proline. PrometheusWiki.
Deloire, A., Pellegrino, A., & Rogiers, S. (2020). A few words on grapevine leaf water potential: Original language of the article: English. IVES Technical Reviews, vine and wine.
Iland P., Bruer N., Edwards G., Weeks S. and Wilkes E. (eds) Chemical analysis of grapes and wine: techniques and concepts. (Patrick land Wine Promotions Pty. Ltd., Campbelltown, 2004).
Ough C S., Amerine M A. 1988. Phenolic compounds. In “Grape pigments. Methods for aanalysis of musts and wines”. Jonh Wiley & Sons, New York: 196-221.
Slinkard K., Singleton V L. 1977. Total Phenol Analysis: Automation and Comparison with Manual Methods. American Journal of Enology and Viticulture 28: 49-55.
Strasser, R. J., Srivastava, A., Govindjee, 1995. Polyphasic chlorophyll a fluorescence transient in plants and cyanobacteria. Photochem. Photobiol. 61: 32-42.

### Further Aspects and Embodiments of the Present Invention

1. A method for: reducing the effects of abiotic stress in a plant and/or a plant part; and/or increasing the tolerance to abiotic stress of a plant and/or a plant part; and/or increasing biomass or yield of a plant and/or a plant part under abiotic stress; wherein said method comprises contacting the plant and/or the plant part or soil with a composition comprising a yeast-derived material.
2. The method of paragraph 1, wherein contacting the plant and/or the plant part or the soil with the composition comprising a yeast-derived material thereby reduces the effects of abiotic stress in the plant and/or the plant part and/or increases the tolerance to abiotic stress of the plant and/or the plant part and/or increases biomass or yield of the plant and/or the plant part compared to an untreated plant and/or plant part.
3. The method of paragraph 1 or 2, wherein the yeast-derived material is a yeast hydrolysate, an inactive yeast, a yeast autolysate, a yeast extract, yeast cell walls or yeast cell-wall derivatives, preferably wherein said yeast-derived material is a yeast hydrolysate, optionally wherein the yeast hydrolysate is obtained through an alkaline hydrolysis and/or an enzymatic hydrolysis and/or an acid hydrolysis and/or a physical treatment and/or mechanical treatment.
4. The method of paragraph 3, wherein the yeast hydrolysate is a yeast alkaline hydrolysate, preferably wherein the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate, optionally wherein:
   (a) said alkaline hydrolysis method is carried out for sufficient time to allow the yeast alkaline hydrolysate to form, such as at least about 30 minutes, or at least about one hour, or for 1 to 20 hours;
   (b) said alkali solution has a pH in the range of 8.5-14, or in the range of about 8.5-11.5;
   (c) the temperature is in the range of 50-120° C., or is in the range of 60-110° C.; and/or
   (d) said yeast cell material is a whole yeast cell material.
5. The method of any one of paragraphs 1 to 4, wherein the yeast of the yeast-derived material is a species from the genera Saccharomyces, Kluyveromyces, Hanseniaspora, Metschnikowia, Pichia, Starmerella, Torulaspora, Brettanomyces, Lachancea, Schizosaccharomyces or Candida, preferably from the genus Saccharomyces, and more preferably the yeast is S. cerevisiae.
6. The method of any one of paragraphs 1 to 5, which further comprises:
   (a) separately, simultaneously or sequentially contacting the plant and/or the plant part with one or more additional agricultural compound; or
   (b) simultaneously contacting the plant and/or the plant part with one or more additional agricultural compound, wherein the one or more additional agricultural compound is provided in the composition comprising the yeast-derived material.
7. The method of paragraph 6, wherein said additional agricultural compound is proline.
8. The method of any one of paragraphs 1 to 7, wherein said abiotic stress is high temperature, heat, drought, water stress, high light intensity, hail, cold temperature, freezing, chilling, salinity, ozone, or combinations thereof, preferably wherein said abiotic stress is high temperature, drought, water stress, high light intensity and/or hail.
9. The method of any one of paragraphs 1 to 8, wherein said plant is a vine and/or said plant part is a part of a vine.
10. The method of any one of paragraphs 1 to 9, wherein:
   (a) the step of contacting the plant and/or the plant part or the soil with the composition comprising the yeast-derived material is performed by applying the yeast-derived material in an amount of in an amount of at least 0.01 kg; 0.02 kg; 0.03 kg; 0.04 kg; 0.05 kg; 0.06 kg; 0.07 kg; 0.08 kg; 0.09 kg; 0.1 kg; 0.2 kg; 0.3 kg; 0.4 kg; 0.5 kg; 0.6 kg; 0.7 kg; 0.8 kg; 0.9 kg; 1 kg; 2 kg, 3 kg; 4 kg; 5 kg, 6 kg; 7 kg; 8 kg; 9 kg; 10 kg; 11 kg; 12 kg; 13 kg; 14 kg; 15 kg; 16 kg; 17 kg; 18 kg; 19 kg; 20 kg; 21 kg; 22 kg; 23 kg; 24 kg; 25 kg; 30 kg; 35 kg; 40 kg; 45 kg; 50 kg; 55 kg; 60 kg; 65 kg; 70 kg; 75 kg; 80 kg; 85 kg; 90 kg; 95 kg or more than 100 kg of dry matter per hectare;
   (b) the composition further comprises an agriculturally acceptable carrier; and/or
   (c) the composition further comprises one or more additional agricultural compound, preferably wherein the one or more additional agricultural compound is proline.
11. Use of a yeast-derived material for: reducing the effects of abiotic stress in a plant and/or a plant part; and/or increasing the tolerance to abiotic stress of a plant and/or a plant part; and/or increasing biomass or yield of a plant and/or plant part, wherein said use comprises contacting the plant and/or the plant part or soil with a composition comprising a yeast-derived material.
12. The use of paragraph 11, wherein contacting the plant and/or the plant part or soil with the composition comprising a yeast-derived material thereby reduces the effects of abiotic stress in the plant and/or the plant part and/or increases the tolerance to abiotic stress of the plant and/or the plant part and/or increases biomass or yield of the plant and/or the plant part compared to an untreated plant and/or plant part.
13. The use of paragraph 11 or 12, wherein the yeast-derived material is a yeast hydrolysate, an inactive yeast, a yeast autolysate, a yeast extract or yeast cell walls, preferably wherein said yeast-derived material is a yeast hydrolysate, more preferably wherein the yeast hydrolysate is obtained through an enzymatic hydrolysis and/or an acid hydrolysis and/or an alkaline hydrolysis and/or a physical treatment and/or mechanical treatment, still more preferably wherein the yeast hydrolysate is obtained by an alkaline hydrolysis method comprising the steps of (i) providing whole yeast cell material; and (ii) subjecting said whole yeast cell material to a chemical treatment with an alkali solution at a pH of above 8 and a temperature of above 45° C. to obtain a yeast hydrolysate, optionally wherein:
   (a) said alkaline hydrolysis method is carried out for sufficient time to allow the yeast alkaline hydrolysate to form, such as at least about 30 minutes, or at least about one hour, or for 1 to 20 hours,
   (b) said alkali solution has a pH in the range of 8.5-14, or in the range of about 8.5-11.5;
   (c) the temperature is in the range of 50-120° C., or is in the range of 60-110° C.; and/or
   (d) said yeast cell material is a whole yeast cell material.
14. The use according to any one of paragraphs 11 to 13, wherein:
   (a) the yeast of the yeast-derived material is a species from the genera Saccharomyces, Kluyveromyces, Hanseniaspora, Metschnikowia, Pichia, Starmerella, Torulaspora or Candida, preferably from the genus Saccharomyces, and more preferably the yeast is S. cerevisiae;
   (b) said abiotic stress is high temperature, heat, drought, water stress, high light intensity, hail, cold temperature, freezing, chilling, salinity, ozone, or combinations thereof, preferably said abiotic stress is high temperature, drought, water stress, high light intensity and/or hail;
   (c) the composition further comprises an agriculturally acceptable carrier; and/or
   (d) the composition further comprises one or more additional agricultural compound, preferably wherein the one or more additional agricultural compound is proline.
15. A composition for: reducing the effects of abiotic stress in a plant and/or a plant part; and/or increasing the tolerance to abiotic stress in a plant and/or a plant part; and/or increasing biomass or yield of a plant and/or plant part under abiotic stress, wherein said composition comprises a yeast-derived material as an active substance and an agriculturally acceptable carrier, optionally wherein said yeast-derived material is a yeast hydrolysate, preferably wherein the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate, optionally wherein:
   (a) said alkaline hydrolysis method is carried out for sufficient time to allow the yeast alkaline hydrolysate to form, such as at least about 30 minutes, or at least about one hour, or for 1 to 20 hours,
   (b) said alkali solution has a pH in the range of 8.5-14, or in the range of about 8.5-11.5;
   (c) the temperature is in the range of 50-120° C., or is in the range of 60-110° C.; and/or
   (d) said yeast cell material is a whole yeast cell material.
16. The composition of paragraph 15, which further comprises one or more additional agricultural compound, preferably wherein the one or more additional agricultural compound is proline.
17. A yeast hydrolysate intended to be used for: reducing the effects of abiotic stress in a plant and/or a plant part; and/or increasing the tolerance to abiotic stress in a plant and/or a plant part; and/or increasing biomass or yield of a plant and/or plant part under abiotic stress, preferably wherein the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate, optionally wherein:
   (a) said alkaline hydrolysis method is carried out for sufficient time to allow the yeast alkaline hydrolysate to form, such as at least about 30 minutes, or at least about one hour, or for 1 to 20 hours,
   (b) said alkali solution has a pH in the range of 8.5-14, or in the range of about 8.5-11.5;
   (c) the temperature is in the range of 50-120° C., or is in the range of 60-110° C.; and/or
   (d) said yeast cell material is a whole yeast cell material.

1. A method for: reducing the effects of abiotic stress in a plant and/or a plant part; and/or increasing the tolerance to abiotic stress of a plant and/or a plant part; and/or increasing biomass or yield of a plant and/or a plant part under abiotic stress; wherein said method comprises contacting the plant and/or the plant part or soil with a composition comprising a yeast-derived material.

2. The method of claim 1, wherein contacting the plant and/or the plant part or the soil with the composition comprising a yeast-derived material thereby reduces the effects of abiotic stress in the plant and/or the plant part and/or increases the tolerance to abiotic stress of the plant and/or the plant part and/or increases biomass or yield of the plant and/or the plant part compared to an untreated plant and/or plant part.

3. The method of claim 1, wherein the yeast-derived material is a yeast hydrolysate, an inactive yeast, a yeast autolysate, a yeast extract, yeast cell walls or yeast cell-wall derivatives, preferably wherein said yeast-derived material is a yeast hydrolysate, optionally wherein the yeast hydrolysate is obtained through an alkaline hydrolysis and/or an enzymatic hydrolysis and/or an acid hydrolysis and/or a physical treatment and/or mechanical treatment.

4. The method of claim 3, wherein the yeast hydrolysate is a yeast alkaline hydrolysate, preferably wherein the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate, optionally wherein:
(a) said alkaline hydrolysis method is carried out for sufficient time to allow the yeast alkaline hydrolysate to form, such as at least about 30 minutes, or at least about one hour, or for 1 to 20 hours;
(b) said alkali solution has a pH in the range of 8.5-14, or in the range of about 8.5-11.5;
(c) the temperature is in the range of 50-120° C., or is in the range of 60-110° C.; and/or
(d) said yeast cell material is a whole yeast cell material.

5. The method of claim 1, wherein the yeast of the yeast-derived material is a species from the genera Saccharomyces, Kluyveromyces, Hanseniaspora, Metschnikowia, Pichia, Starmerella, Torulaspora, Brettanomyces, Lachancea, Schizosaccharomyces or Candida, preferably from the genus Saccharomyces, and more preferably the yeast is S. cerevisiae.

6. The method of claim 1, which further comprises:
(a) separately, simultaneously or sequentially contacting the plant and/or the plant part with one or more additional agricultural compound; or
(b) simultaneously contacting the plant and/or the plant part with one or more additional agricultural compound, wherein the one or more additional agricultural compound is provided in the composition comprising the yeast-derived material.

7. The method of claim 6, wherein said additional agricultural compound is proline.

8. The method of claim 7, wherein the yeast derived-material is a yeast hydrolysate and the additional agricultural compound is proline, and wherein the yeast hydrolysate and the proline are contacted to the plant, plant part or soil at a percentage weight ratio of from 80:20 to 20:80% w/w, optionally about 75:25% w/w or about 50:50% w/w.

9. The method of claim 1, wherein said abiotic stress is high temperature, heat, drought, water stress, high light intensity, hail, cold temperature, freezing, chilling, salinity, ozone, or combinations thereof, preferably wherein said abiotic stress is high temperature, drought, water stress, high light intensity and/or hail.

10. The method of claim 1, wherein said abiotic stress is water stress.

11. The method of claim 1, wherein said abiotic stress is hail.

12. The method of claim 1, wherein said plant is a vine and/or said plant part is a part of a vine.

13. The method of claim 1, wherein:
(a) the step of contacting the plant and/or the plant part or the soil with the composition comprising the yeast-derived material is performed by applying the yeast-derived material in an amount of in an amount of at least 0.01 kg; 0.02 kg; 0.03 kg; 0.04 kg; 0.05 kg; 0.06 kg; 0.07 kg; 0.08 kg; 0.09 kg; 0.1 kg; 0.2 kg; 0.3 kg; 0.4 kg; 0.5 kg; 0.6 kg; 0.7 kg; 0.8 kg; 0.9 kg; 1 kg; 2 kg, 3 kg; 4 kg; 5 kg, 6 kg; 7 kg; 8 kg; 9 kg; 10 kg; 11 kg; 12 kg; 13 kg; 14 kg; 15 kg; 16 kg; 17 kg; 18 kg; 19 kg; 20 kg; 21 kg; 22 kg; 23 kg; 24 kg; 25 kg; 30 kg; 35 kg; 40 kg; 45 kg; 50 kg; 55 kg; 60 kg; 65 kg; 70 kg; 75 kg; 80 kg; 85 kg; 90 kg; 95 kg or more than 100 kg of dry matter per hectare;
(b) the composition further comprises an agriculturally acceptable carrier; and/or
(c) the composition further comprises one or more additional agricultural compound, preferably wherein the one or more additional agricultural compound is proline, optionally wherein said yeast derived-material is a yeast hydrolysate and said one or more additional agricultural compound is proline, and optionally wherein said yeast hydrolysate and said proline is provided in the composition at a percentage weight ratio from 80:20 to 20:80% w/w, optionally about 75:25% w/w or about 50:50% w/w.

14-17. (canceled)

18. A composition for: reducing the effects of abiotic stress in a plant and/or a plant part; and/or increasing the tolerance to abiotic stress in a plant and/or a plant part; and/or increasing biomass or yield of a plant and/or plant part under abiotic stress,
wherein said composition comprises a yeast-derived material as an active substance and an agriculturally acceptable carrier, optionally wherein said yeast-derived material is a yeast hydrolysate,
preferably wherein the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate, optionally wherein:
(a) said alkaline hydrolysis method is carried out for sufficient time to allow the yeast alkaline hydrolysate to form, such as at least about 30 minutes, or at least about one hour, or for 1 to 20 hours,
(b) said alkali solution has a pH in the range of 8.5-14, or in the range of about 8.5-11.5;
(c) the temperature is in the range of 50-120° C., or is in the range of 60-110° C.; and/or
(d) said yeast cell material is a whole yeast cell material.

19. The composition of claim 18, which further comprises one or more additional agricultural compound, preferably wherein the one or more additional agricultural compound is proline.

20. The composition of claim 18, wherein the yeast derived-material is a yeast hydrolysate and the additional agricultural compound is proline.

21. The composition of claim 20 wherein the yeast hydrolysate and the proline are provided in the composition at a percentage weight ratio of from 80:20 to 20:80% w/w, optionally about 75:25% w/w or about 50:50% w/w.

22. A yeast hydrolysate intended to be used for: reducing the effects of abiotic stress in a plant and/or a plant part; and/or increasing the tolerance to abiotic stress in a plant and/or a plant part; and/or increasing biomass or yield of a plant and/or plant part under abiotic stress, preferably wherein the yeast hydrolysate is obtained by an alkaline hydrolysis method comprising the steps of (i) providing yeast cell material; and (ii) subjecting said yeast cell material to a chemical treatment with an alkali solution at a pH of above 8 and a temperature of above 45° C. to obtain a yeast hydrolysate, optionally wherein:
(a) said alkaline hydrolysis method is carried out for sufficient time to allow the yeast alkaline hydrolysate to form, such as at least about 30 minutes, or at least about one hour, or for 1 to 20 hours,
(b) said alkali solution has a pH in the range of 8.5-14, or in the range of about 8.5-11.5;
(c) the temperature is in the range of 50-120° C., or is in the range of 60-110° C.; and/or
(d) said yeast cell material is a whole yeast cell material.
